(19) United States
(12) Patent Application Publication
(10) Pub. No.: US 2020/0311998 A1
(43) Pub. Date: Oct. 1, 2020

(54) IMAGE PROCESSING METHOD, PROGRAM, AND IMAGE PROCESSING SYSTEM

(71) Applicant: FUJIFILM Corporation, Tokyo (JP)

(72) Inventor: Kimiko TACHIKAWA, Tokyo (JP)

(73) Assignee: FUJIFILM Corporation, Tokyo (JP)

(21) Appl. No.: 16/828,586

(22) Filed: Mar. 24, 2020

(30) Foreign Application Priority Data
Mar. 26, 2019 (JP) 2019-058895

(51) Int. Cl. G06T 11/60; G06F 40/106; G06T 7/90

(52) U.S. Cl. CPC G06T 11/60; G06T 2207/10024; G06T 7/90; G06F 40/106

(57) ABSTRACT

An image processing method, a program, and an image processing system for conveniently enjoying kanji are provided.

An image processing method including an image analysis step of analyzing an acquired image and extracting an object from the image, a kanji string decision step of deciding a kanji string that includes one or more kanji characters related to the object, an alphabet character string decision step of deciding an alphabet character string related to a meaning of the kanji string, a layout decision step of deciding a layout in which the kanji string and the alphabet character string are composited with the image, and a composition step of generating a composite image by compositing the kanji string and the alphabet character string with the image based on the layout is performed.

### CROSS-REFERENCE TO RELATED APPLICATIONS

The present application claims priority under 35 U.S.C. § 119 to Japanese Patent Application No. 2019-058895, filed on Mar. 26, 2019. The above application is hereby expressly incorporated by reference, in its entirety, into the present application.

### BACKGROUND OF THE INVENTION

### 1. Field of the Invention

The present invention relates to an image processing method, a program, and an image processing system and particularly, to a content for enjoying kanji.

### 2. Description of the Related Art

Kanji is unusual for foreigners who visit Japan and particularly do not usually use kanji. Kanji may be provided on products such as clothing and postcards as a target of appreciation. In addition, electronic contents in which kanji is composited are loved and purchased by foreigners.

Examples of a way of making foreigners enjoy kanji include creation of a seal in which kanji in Japanese and alphabets are used on a seal surface, creation of a kanji name by arranging one or more corresponding phonetically equivalent characters in correspondence with pronunciation of a foreign name, and the like are exemplified. However, in any of the examples, an original text is translated, or kanji itself presented to foreigners is individually considered by Japanese people.

JP2018-151829A discloses an information display system that displays character information related to a subject of a captured image in overlay on the captured image. The system displays a name of a mountain in superimposition with a captured image of the mountain, and displays a name of a lake in superimposition with a captured image of the lake.

JP6063536B discloses a camera that can search for an image recorded in a recording unit. The camera disclosed in JP6063536B searches for the image recorded in the recording unit based on a keyword that is input using an electronic keyboard displayed on a liquid crystal display unit.

JP5341946B discloses a home theater system that plays back a video work. In the disclosure of JP5341946B, a PG stream is described as a graphics stream that shows graphics to be precisely synchronized with pictures such as a subtitle of a video, and streams for a plurality of languages such as English are present. PG is the abbreviation for Presentation Graphics.

### SUMMARY OF THE INVENTION

However, contents for making foreign tourists visiting Japan conveniently enjoy kanji is not present. In addition, any of the inventions disclosed in JP2018-151829A, JP6063536B, and JP5341946B is not related to making foreign tourists conveniently enjoy kanji.

The present invention is conceived in view of the above matter. An object of the present invention is to provide an image processing method, a program, and an image processing system for conveniently enjoying kanji.

In order to achieve the object, the following aspects of the invention are provided.

An image processing method according to a first aspect is an image processing method comprising an image analysis step of analyzing an image and extracting an object from the image; a kanji string decision step of deciding a kanji string that includes one or more kanji characters related to the object; an alphabet character string decision step of deciding an alphabet character string related to a meaning of the kanji string; a layout decision step of deciding a layout in which the kanji string and the alphabet character string are composited with the image as a decided layout; and a composition step of generating a composite image by compositing the kanji string and the alphabet character string with the image based on the decided layout.

According to the first aspect, the kanji string related to the object included in the acquired image and the alphabet character string related to the meaning of the kanji string are composited with the image. Accordingly, details of the kanji string can be perceived from a meaning of the alphabet character string, and foreigners and the like can conveniently enjoy kanji.

A subject such as a person, a natural structure, and a building in the image may be applied to the object included in the image. A background such as emptiness and a scene in the image may be applied to the object. In the image analysis step, one object may be extracted from a plurality of objects, or two or more objects may be extracted.

Kanji used in the Japanese language may be applied to the kanji. Kanji used in a foreign country such as China may be applied to the kanji.

Examples of the kanji string related to the object include a kanji string that represents details of the object, a kanji string that represents an image of the object, a kanji string that is imaginable from the object, and the like.

A foreign word such as an English word that represents the meaning of the kanji string may be applied to the alphabet character string. The alphabet character string may include a specific sign and the like such as a hashtag.

Examples of the alphabet character string related to the kanji string include an alphabet character string that represents the meaning of the kanji string, an alphabet character string that represents an image of the kanji string, an alphabet character string that is imaginable from the kanji string, and the like.

The layout may include information of a position of the object. The layout may include information of a position of the kanji string in the image, a color of the kanji string, a font of the kanji string, and the like. The layout may include information of a position of the alphabet character string in the image, a color of the alphabet character string, a font of the alphabet character string, and the like.

Coordinate values in the image may be applied to the information of the position of the object, the information of the position of the kanji string, and the information of the position of the alphabet character string.

A second aspect may be configured such that in the image processing method of the first aspect, in the layout decision step, a layout in which the alphabet character string is arranged in a region in which the kanji string is arranged is decided as a decided layout.

According to the second aspect, the kanji string and the alphabet character string may be visually recognized together. In addition, integrity between the kanji string and the alphabet character string may be represented.

A third aspect may be configured such that in the image processing method of the first aspect or the second aspect, in the layout decision step, a layout in which at least a part of the kanji string is arranged at a position overlapping the object is decided as the decided layout.

According to the third aspect, the composite image of excellent design quality in which the image, the kanji string, and the alphabet character string are composited may be implemented. In addition, a correspondence relationship between the object and the kanji string may be perceived.

A fourth aspect may be configured such that in the image processing method of any one aspect of the first aspect to the third aspect, in the layout decision step, a layout in which the kanji string is arranged in a foreground of the object is decided as the decided layout.

According to the fourth aspect, the kanji string can stand out in the composite image.

In the fourth aspect, a layout in which the alphabet character string is arranged in the foreground of the object may be decided as the decided layout.

A fifth aspect may be configured such that in the image processing method of any one aspect of the first aspect to the fourth aspect, in the layout decision step, a layout in which the object is arranged in a foreground of the kanji string is decided as the decided layout.

According to the fifth aspect, kanji related to the object can be enjoyed without affecting presence of the object in the composite image.

In the fifth aspect, a layout in which the object is arranged in a foreground of the alphabet character string may be decided as the decided layout.

A sixth aspect may be configured such that in the image processing method of any one aspect of the first aspect to the fifth aspect, in the layout decision step, a layout in which the object is seen through at least a part of the kanji string is decided as the decided layout.

According to the sixth aspect, the kanji string can stand out in the composite image, and the kanji related to the object can be enjoyed without affecting the presence of the object in the composite image.

In the sixth aspect, a layout in which the object is seen through at least a part of the alphabet character string may be decided as the decided layout.

A seventh aspect may be configured such that in the image processing method of any one aspect of the first aspect to the sixth aspect, in the image analysis step, a color used in the object is extracted as an extracted color, and in the layout decision step, the extracted color is employed as a color of the kanji string.

According to the seventh aspect, harmony of color between the image and the kanji string may be implemented in the composite image.

In the seventh aspect, the extracted color of the image may be employed as a color of the alphabet character string. Accordingly, harmony of color as the entire composite image may be implemented.

An eighth aspect may be configured such that in the image processing method of any one aspect of the first aspect to the seventh aspect, in the image analysis step, a plurality of the objects are extracted from the image, and in the layout decision step, a layout in which the kanji string is arranged in each of the plurality of objects is decided as the decided layout.

According to the eighth aspect, the composite image in which the kanji string is highlighted and excellent design quality is obtained may be generated.

In the eighth aspect, one kanji string and one alphabet character string as a set may be composited with one object.

A ninth aspect may be configured such that in the image processing method of any one aspect of the first aspect to the eighth aspect, in the layout decision step, a layout in which the kanji string is arranged in a direction corresponding to a direction of the object is decided as the decided layout.

According to the ninth aspect, the composite image in which integrity between the object and the kanji string is represented and excellent design quality is obtained may be generated.

In the ninth aspect, a direction of the alphabet character string may be set to correspond to the direction of the object.

A tenth aspect may be configured such that in the image processing method of any one aspect of the first aspect to the ninth aspect, in the layout decision step, a layout in which one or more kanji characters included in the kanji string are arranged on an edge of the image is decided as the decided layout.

According to the tenth aspect, the composite image in which the kanji is highlighted and excellent design quality is obtained may be generated.

An eleventh aspect may be configured such that in the image processing method of any one aspect of the first aspect to the tenth aspect, in the kanji string decision step, the kanji string is decided from a plurality of kanji string candidates related to the object.

According to the eleventh aspect, the number of selections of the kanji string for the extracted object can be increased.

A twelfth aspect may be configured such that in the image processing method of any one aspect of the first aspect to the eleventh aspect, in the alphabet character string decision step, the alphabet character string is decided from a plurality of alphabet character string candidates related to the meaning of the kanji string.

According to the twelfth aspect, one or more alphabet character strings may be selected from the plurality of alphabet character string candidates for the kanji string.

A thirteenth aspect may be configured such that the image processing method of any one aspect of the first aspect to the twelfth aspect further comprises a kanji string correction step of correcting the kanji string decided in the kanji string decision step to another kanji string related to the object. For example, alphabet character string related to a meaning of the another kanji string is decided in the alphabet character string decision step, and a layout in which the another kanji string and the alphabet character string are composited with the image is decided as a decided layout in the layout decision step, and a composite image by compositing the another kanji string and the alphabet character string with the image based on the decided layout is generated in the composition step.

According to the thirteenth aspect, the kanji string can be corrected.

In the thirteenth aspect, a user may manually correct the kanji string using a user interface.

In the thirteenth aspect, the alphabet character string may be manually corrected or automatically corrected in accordance with the corrected kanji string.

A fourteenth aspect may be configured such that the image processing method of any one aspect of the first aspect to the thirteenth aspect further comprises an alphabet character string correction step of correcting the alphabet character string to another alphabet character string related to the meaning of the kanji string. For example, a layout in which the kanji string and the another alphabet character string are composited with the image is decided as a decided layout in the layout decision step, and a composite image by compositing the another kanji string and the another alphabet character string with the image based on the decided layout is generated in the composition step.

According to the fourteenth aspect, the alphabet character string can be corrected.

In the fourteenth aspect, the user may manually correct the alphabet character string using the user interface.

A fifteenth aspect may be configured such that the image processing method of any one aspect of the first aspect to the fourteenth aspect further comprises a printing step of printing the composite image using a printing apparatus (printer).

According to the fifteenth aspect, a printed material on which the composite image is printed may be provided. Accordingly, the kanji can be enjoyed using the printed material.

A program according to a sixteenth aspect is a program causing a computer to implement an image analysis function of analyzing an acquired image and extracting an object from the image, a kanji string decision function of deciding a kanji string that includes one or more kanji characters related to the object, an alphabet character string decision function of deciding an alphabet character string related to a meaning of the kanji string, a layout decision function of deciding a layout in which the kanji string and the alphabet character string are composited with the image, and a composition function of generating a composite image by compositing the kanji string and the alphabet character string with the image based on the layout.

According to the sixteenth aspect, the same effect as the first aspect can be obtained.

In the sixteenth aspect, the same matters as the matters specified in the second aspect to the fifteenth aspect can be appropriately combined. In this case, a constituent performing a process or a function specified in the image processing method can be perceived as a constituent of the program for performing the corresponding process or function.

An image processing system according to a seventeenth aspect is an image processing system comprising an image analysis unit that analyzes an acquired image and extracts an object from the image, a kanji string decision unit that decides a kanji string which includes one or more kanji characters related to the object, an alphabet character string decision unit that decides an alphabet character string related to a meaning of the kanji string, a layout decision unit that decides a layout in which the kanji string and the alphabet character string are composited with the image, and a composition unit that generates a composite image by compositing the kanji string and the alphabet character string with the image based on the layout.

According to the seventeenth aspect, the same effect as the first aspect can be obtained.

In the seventeenth aspect, the same matters as the matters specified in the second aspect to the fifteenth aspect can be appropriately combined. In this case, a constituent performing a process or a function specified in the image processing method can be perceived as a constituent of the image processing system performing the corresponding process or function.

An eighteenth aspect may be configured such that the image processing system of the seventeenth aspect further comprises a printing unit that prints the composite image.

According to the eighteenth aspect, the printed material on which the composite image is printed may be provided. Accordingly, the kanji can be enjoyed using the printed material.

An image processing system according to a nineteenth aspect is an image processing system connected through a network. The system comprises an image analysis unit that analyzes an acquired image and extracts an object from the image, a kanji string decision unit that decides a kanji string which includes one or more kanji characters related to the object, an alphabet character string decision unit that decides an alphabet character string related to a meaning of the kanji string, a layout decision unit that decides a layout in which the kanji string and the alphabet character string are composited with the image, and a composition unit that generates a composite image by compositing the kanji string and the alphabet character string with the image based on the layout.

According to the nineteenth aspect, the same effect as the first aspect can be obtained.

In the nineteenth aspect, the same matters as the matters specified in the second aspect to the fifteenth aspect can be appropriately combined. In this case, a constituent performing a process or a function specified in the image processing method can be perceived as a constituent of the image processing system performing the corresponding process or function.

A twentieth aspect may be configured such that the image processing system of the nineteenth aspect further comprises a printing apparatus (printer) that is connected through the network and prints the composite image.

According to the twentieth aspect, the printed material on which the composite image is printed may be provided. Accordingly, the kanji can be enjoyed using the printed material.

A twenty-first aspect may be configured such that in the image processing system of the twentieth aspect, the printing apparatus (printer) includes the image analysis unit, the kanji string decision unit, the alphabet character string decision unit, the layout decision unit, and the composition unit and prints the composite image based on the image.

According to the twenty-first aspect, the printing apparatus (printer) may acquire the image of a processing target from a terminal apparatus, generate the composite image based on the acquired image, and provide the printed material on which the composite image is printed to the user.

A twenty-second aspect may be configured such that the image processing system of the nineteenth aspect or the twentieth aspect further comprises a server apparatus that is connected through the network and includes the image analysis unit, the kanji string decision unit, the alphabet character string decision unit, the layout decision unit, and the composition unit.

According to the twenty-second aspect, the composite image can be generated using the server apparatus connected to the network.

According to the present invention, the kanji string related to the object included in the acquired image and the alphabet character string related to the meaning of the kanji string are composited with the image. Accordingly, details of the kanji string can be perceived from a meaning of the alphabet character string, and foreigners and the like can conveniently enjoy kanji.

### BRIEF DESCRIPTION OF THE DRAWINGS

FIG. 1 is a function block diagram of an image processing system according to a first embodiment.

FIG. 2 is a front view of a smartphone according to a specific example of an image processing apparatus illustrated in FIG. 1.

FIG. 3 is a flowchart illustrating a procedure of image processing method according to the first embodiment.

FIG. 4 is a descriptive diagram illustrating a specific example of a composite image.

FIG. 5 is a descriptive diagram illustrating a specific example of the composite image in a case where another subject in the image illustrated in FIG. 4 is extracted as an object.

FIG. 6 is a descriptive diagram illustrating a specific example of the composite image in a case where still another subject in the image illustrated in FIG. 4 is extracted as an object.

FIG. 7 is a descriptive diagram of a specific example of a kanji template database.

FIG. 8 is a configuration diagram of an image processing system according to a second embodiment.

FIG. 9 is a function block diagram of a self-printing terminal apparatus illustrated in FIG. 8.

FIG. 10 is a flowchart illustrating a procedure of image processing method according to the second embodiment.

FIG. 11 is a function block diagram of a layout decision unit in an image processing system according to a third embodiment.

FIG. 12 is a screen diagram illustrating one example of a layout setting screen in the image processing system according to the third embodiment.

FIG. 13 is a flowchart illustrating a procedure of layout decision step in an image processing method according to the third embodiment.

FIG. 14 is a descriptive diagram of a composite image according to a first specific example.

FIG. 15 is a descriptive diagram of a composite image according to a second specific example.

FIG. 16 is a descriptive diagram of a composite image according to a third specific example.

FIG. 17 is a descriptive diagram of a composite image according to a fourth specific example.

FIG. 18 is a descriptive diagram of a composite image according to a fifth specific example.

FIG. 19 is a descriptive diagram of a composite image according to a sixth specific example.

FIG. 20 is a descriptive diagram of a composite image according to a seventh specific example.

FIG. 21 is a descriptive diagram of a composite image according to an eighth specific example.

FIG. 22 is a descriptive diagram of a composite image according to a ninth specific example.

FIG. 23 is a descriptive diagram of a composite image according to a tenth specific example.

FIG. 24 is a descriptive diagram of a composite image according to an eleventh specific example.

FIG. 25 is a descriptive diagram of a composite image according to a twelfth specific example.

FIG. 26 is a descriptive diagram of a composite image according to a thirteenth specific example.

### DESCRIPTION OF THE PREFERRED EMBODIMENTS

Hereinafter, preferred embodiments of the present invention will be described in accordance with the appended drawings. In the present specification, the same constituents will be designated by the same reference signs, and duplicate descriptions of such constituents will be appropriately omitted.

Overall Configuration of Image Processing System

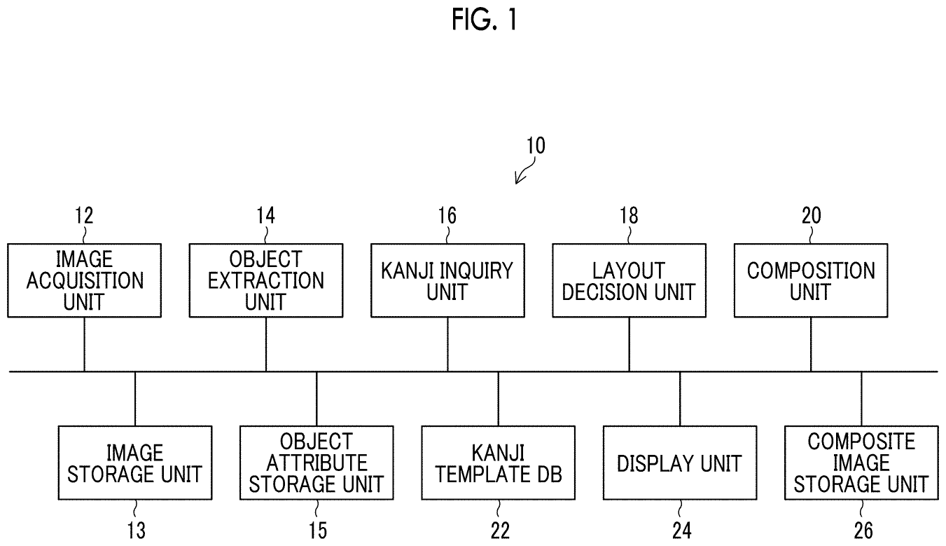

FIG. 1 is a function block diagram of an image processing system according to a first embodiment. An image processing system 10 illustrated in FIG. 1 generates a composite image by compositing a kanji string related to an object extracted from an image and an alphabet character string related to a meaning of the kanji string in the image. In a case where a signal representing the composite image is transmitted to a printing terminal apparatus, the printing terminal apparatus generates a printed material on which the composite image is printed.

Hereinafter, an example in which one kanji character is applied as the kanji string and a hashtag is applied as the alphabet character string will be described. In the present specification, the term image may not only represent the image itself but also represent image data that is a signal representing the image. The hashtag is a label in which a hash sign is provided ahead of the alphabet character string.

The alphabet is any character that belongs to a character system that is applied to any language and has a constant arrangement order. For example, examples include a Latin character, a Greek character, and a Cyrillic character.

A mobile terminal apparatus such as a smartphone may be applied to the image processing system 10. A computer such as a personal computer may also be applied to the image processing system 10. A desktop type computer, a laptop type computer, a tablet type computer, and the like may be applied to the computer.

Application software that generates the composite image is installed on the image processing system 10. The image processing system 10 may implement each function in the generation of the composite image by executing the application software generating the composite image.

The image processing system 10 comprises an image acquisition unit 12 and an image storage unit 13. The image acquisition unit 12 acquires an image that is captured using an imaging apparatus or the like incorporated in the smartphone. The image acquisition unit 12 stores the acquired image in the image storage unit 13.

The image processing system 10 may acquire an image of a processing target from an external storage device. For example, the image acquisition unit 12 may acquire the image of the processing target through a communication interface, not illustrated, such as a USB port and a slot into which a memory card can be inserted. USB is the abbreviation for Universal Serial Bus.

The image processing system 10 comprises an object extraction unit 14. The object extraction unit 14 analyzes the image of the processing target and extracts one or more objects from the image of the processing target. A well-known image processing technology may be applied to the object extraction. The object extraction unit 14 may extract a main subject or a constituent of a background as an object.

The object extraction unit 14 extracts object attribute information from the object extracted from the image of the processing target. The object attribute information may include a type of object, a direction of the object, a size of the object, a position of the object in the image, a color of the object, and the like. The object extraction unit 14 stores the object attribute information in an object attribute information storage unit 15 in association with the image. The object extraction unit 14 illustrated in the embodiment corresponds to one example of an image analysis unit.

The image processing system 10 comprises a kanji inquiry unit 16 and a kanji template database 22. By referring to the kanji template database 22, the kanji inquiry unit 16 inquires kanji representing details of the object and a hashtag representing a meaning of the kanji using the object attribute information as a parameter.

The kanji representing the details of the object corresponds to one example of a kanji string that includes one or more kanji characters related to an object. The hashtag representing the meaning of the kanji corresponds to one example of an alphabet character string related to a meaning of the kanji string.

The kanji template database 22 stores a combination of kanji representing a subject or the like imageable using the imaging apparatus or the like of the smartphone and the hashtag representing the meaning of the kanji in association with the subject. The kanji template database 22 may store a template obtained by combining the kanji with the hashtag in association with the subject.

That is, from the kanji template database 22, the kanji inquiry unit 16 reads out the template obtained by combining the kanji corresponding to the object attribute information with the hashtag. DB shown in FIG. 1 and the like is the abbreviation for Data Base.

The kanji template database 22 may be included outside the image processing system 10. The kanji template database 22 may be communicably connected to the image processing system 10 through a network or the like.

The image processing system 10 comprises a layout decision unit 18. The layout decision unit 18 decides a layout such as a position of the kanji template, which is read out from the kanji template database 22 using the kanji inquiry unit 16, in the image, a size of the kanji template, and a color of the kanji template in the composite image.

The layout decision unit 18 illustrated in the embodiment corresponds to one example of a kanji string decision unit that decides the kanji string including one or more kanji characters related to the object. In addition, the layout decision unit 18 corresponds to one example of an alphabet character string decision unit that decides the alphabet character string related to the meaning of the kanji string.

The image processing system 10 comprises a composition unit 20. The composition unit 20 generates the composite image by compositing the kanji template determined using the layout decision unit 18 with the image of the processing target.

The image processing system 10 comprises a display unit 24. A liquid crystal display of the smartphone is applied to the display unit 24. The display unit 24 displays the composite image generated using the composition unit 20.

The image processing system 10 comprises a composite image storage unit 26. In a case where the composition unit 20 acquires an instruction signal that represents that the composite image is stored, the composition unit 20 stores the composite image in the composite image storage unit 26.

Hardware Configuration of Image Processing System

Various processors may be applied to hardware of various processing units illustrated in FIG. 1. A central processing unit (CPU) and a graphics processing unit (GPU) may be applied to the various processors. The CPU is a general-purpose processor that functions as various processing units by executing a program. The GPU is a processor that is specialized in image processing.

A device that includes a dedicated electric circuit or the like may be applied as the various processors. Examples of the device including the dedicated electric circuit include a programmable logic device (PLD) and an application specific integrated circuit (ASIC). The PLD is a processor of which a circuit configuration can be changed after manufacturing of the device. The ASIC is a processor that has a circuit configuration dedicatedly designed to execute a specific process.

One processing unit may be configured using one of the above processors or may be configured using two or more of the above processors. Examples of configuring one processing unit using two or more of the processors include an example of configuring one processing unit using processors of the same type, and an example of configuring one processing unit using processors of different types.

An example of configuring one processing unit using processors of the same type is an example of using two or more FPGAs. An example of configuring one processing unit using the processors of different types is an example of configuring one processing unit using one or more CPUs and one or more FPGAs.

A plurality of processing units may be configured using one processor. An example of configuring the plurality of processing units using one processor is a form in which one processor is configured by applying a combination of one or more CPUs and a program and the processor having such configuration functions as the plurality of processing units. Specific examples of such a form include computers such as a server apparatus and a client apparatus.

Another example of configuring the plurality of processing units using one processor is a form in which using one IC chip, a processor that implements a function of the entire system including the plurality of processing units is used.

A specific example of such a form is a system on chip. IC is the abbreviation for Integrated Circuit. The system on chip may be referred to as a system on chip (SoC) using an English representation.

Various processing units are configured using one or more of the various processors as a hardware structure. The hardware structure of the various processors is an electric circuit in which circuit elements such as semiconductor elements are combined. The electric circuit may be referred to as circuitry using an English representation.

Specific Example of Image Processing Apparatus

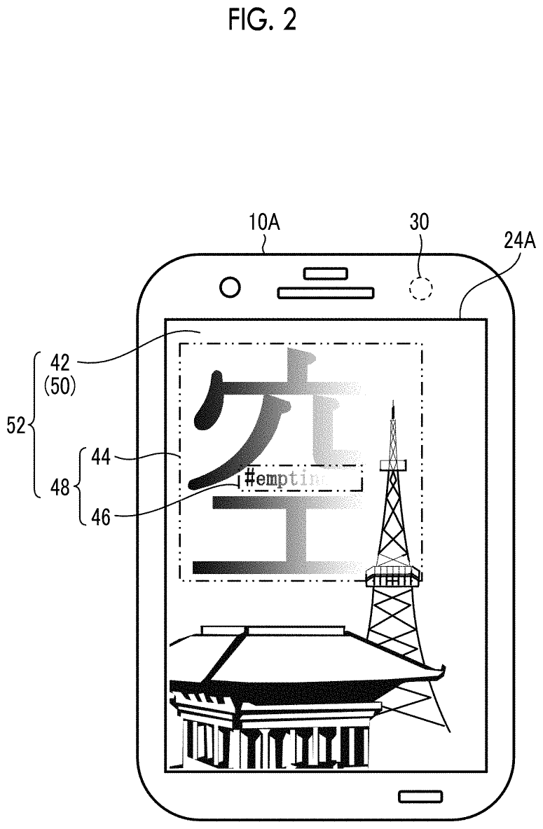

FIG. 2 is a front view of the smartphone according to a specific example of an image processing apparatus illustrated in FIG. 1. A smartphone 10A illustrated in FIG. 2 displays a composite image 52 using a liquid crystal display 24A. Composite image generation application software is installed in advance on the smartphone 10A. Hereinafter, the composite image generation application software will be referred to as the application.

An operator of the smartphone 10A starts the application. The operator of the smartphone 10A starts an imaging apparatus 30 incorporated in the smartphone 10A and starts imaging. The liquid crystal display 24A displays a live view image. The imaging apparatus 30 disclosed in the embodiment corresponds to one example of an image acquisition unit.

In a case where a prescribed subject enters a focus region, a kanji template 48 that includes a kanji string 44 including one or more kanji characters corresponding to an object 42 which is the subject, and includes a hashtag 46 representing a meaning of the kanji string 44 is read out. The kanji template 48 is composited in an image 50 that includes the object 42. The composite image 52 in which the kanji template 48 is composited in the image 50 is displayed on the liquid crystal display 24A.

In a case where an imaging button not illustrated is operated in a state where the composite image 52 is displayed on the liquid crystal display 24A, the imaging apparatus 30 stores the image 50. The application generates the composite image 52 in which the kanji template 48 is composited in the image 50. The application stores the composite image 52.

Flowchart of Image Processing Method

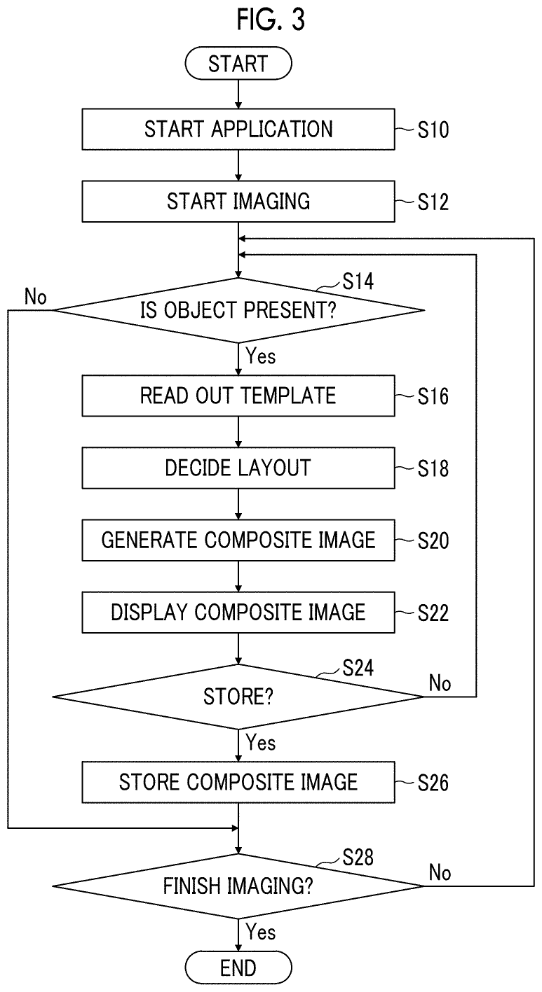

FIG. 3 is a flowchart illustrating a procedure of image processing method according to the first embodiment. In application start step S10, the operator of the smartphone 10A illustrated in FIG. 2 starts the application by operating an operation button of the smartphone 10A. After application start step S10, the procedure of image processing method proceeds to imaging start step S12.

In imaging start step S12, the operator of the smartphone 10A starts the imaging apparatus 30 incorporated in the smartphone 10A by operating the operation button of the smartphone 10A. The operator of the smartphone 10A directs a lens of the imaging apparatus 30 to an imaging target. The lens of the imaging apparatus 30 is not illustrated. The liquid crystal display 24A of the smartphone 10A displays a live view image of the imaging target. After imaging start step S12, the procedure of image processing method proceeds to object extraction step S14.

In object extraction step S14, the object extraction unit 14 illustrated in FIG. 1 determines whether or not the prescribed subject enters the focus region of the imaging apparatus 30. In object extraction step S14, a No determination is made in a case where the object extraction unit 14 determines that the prescribed subject does not enter the focus region of the imaging apparatus 30. In the case of the No determination, the procedure of image processing method proceeds to imaging finish determination step S28.

Meanwhile, in object extraction step S14, a Yes determination is made in a case where the object extraction unit 14 determines that the prescribed subject enters the focus region of the imaging apparatus 30. In the case of the Yes determination, the object extraction unit 14 extracts the prescribed subject as the object 42, and the procedure of image processing method proceeds to template reading step S16. Object extraction step S14 illustrated in the embodiment corresponds to one example of an image analysis step.

In template reading step S16, the kanji inquiry unit 16 reads out the kanji template 48 corresponding to the object 42 from the kanji template database 22. After template reading step S16, the procedure of image processing method proceeds to layout decision step S18.

Template reading step S16 illustrated in the embodiment corresponds to one example of a kanji string decision step of deciding a kanji string that includes one or more kanji characters related to an object. In addition, template reading step S16 corresponds to one example of an alphabet character string decision step of deciding an alphabet character string related to a meaning of the kanji string.

In layout decision step S18, the layout decision unit 18 decides a layout of the composite image 52 based on the kanji template 48 and the image 50. After layout decision step S18, the procedure of image processing method proceeds to composite image generation step S20.

Layout decision step S18 may include a kanji string correction step of correcting the decided kanji string 44. In addition, layout decision step S18 may include a hashtag correction step of correcting the decided hashtag 46. The hashtag correction step illustrated in the embodiment corresponds to one example of an alphabet character string correction step.

In composite image generation step S20, the composition unit 20 generates the composite image 52 in which the kanji template 48 and the image 50 are composited. After composite image generation step S20, the procedure of image processing method proceeds to composite image display step S22.

In composite image display step S22, the display unit 24 displays the composite image 52. After composite image display step S22, the procedure of image processing method proceeds to composite image storage determination step S24.

In composite image storage determination step S24, the image processing system 10 determines whether or not the imaging button of the smartphone 10A is operated from a timing at which the composite image is displayed on the display unit 24.

In composite image storage determination step S24, a No determination is made in a case where it is determined that a certain period elapses in the image processing system 10 without operating the imaging button of the smartphone 10A from the timing at which the composite image is displayed on the display unit 24. In the case of the No determination, the procedure of image processing method proceeds to object extraction step S14. Then, each step of object extraction step S14 to composite image storage determination step S24 is repeatedly performed until a Yes determination is made in composite image storage determination step S24.

Meanwhile, in composite image storage determination step S24, the Yes determination is made in a case where it is determined that the imaging button of the smartphone 10A is operated in the image processing system 10 within an elapse of a certain period from the timing at which the composite image is displayed on the display unit 24. In the case of the Yes determination, the procedure of image processing method proceeds to composite image storage step S26.

In composite image storage step S26, the composition unit 20 stores the composite image 52 in the composite image storage unit 26. After composite image storage step S26, the procedure of image processing method proceeds to imaging finish determination step S28.

In imaging finish determination step S28, the image processing system 10 determines whether or not to finish imaging. In imaging finish determination step S28, a No determination is made in a case where the image processing system 10 determines not to finish imaging. In the case of the No determination, the procedure of image processing method proceeds to object extraction step S14, and each step of object extraction step S14 to imaging finish determination step S28 is repeatedly performed until a Yes determination is made in imaging finish determination step S28.

Meanwhile, in imaging finish determination step S28, the Yes determination is made in a case where the image processing system 10 determines to finish imaging. In the case of the Yes determination, the image processing system 10 finishes the image processing method.

Specific Example of Composite Image

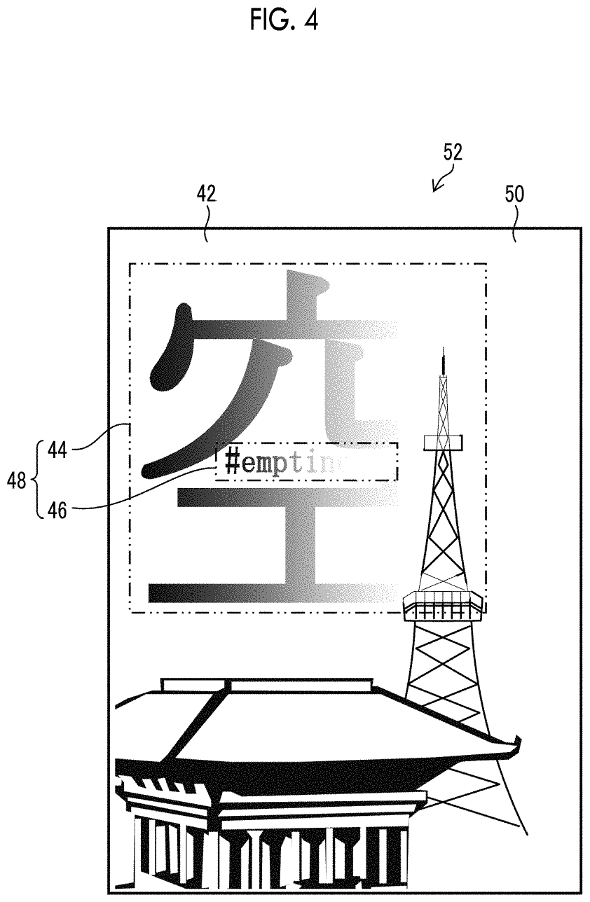

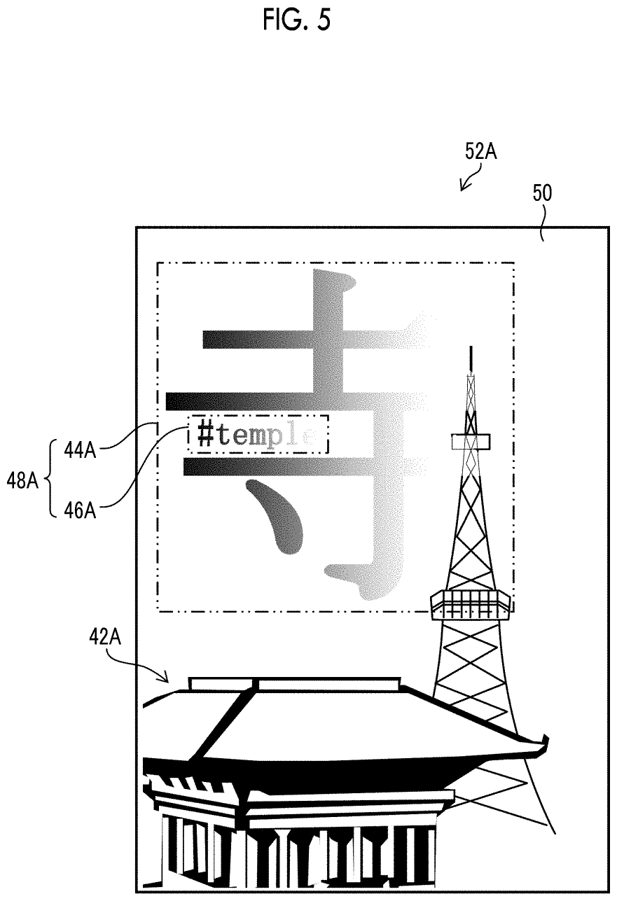

Next, a specific example of the composite image will be described. FIG. 4 is a descriptive diagram illustrating a specific example of the composite image. The composite image 52 illustrated in FIG. 4 is the same as the composite image 52 illustrated in FIG. 2. FIG. 5 illustrates the kanji template 48 in a case where emptiness is recognized as the subject of the image 50 and emptiness is extracted as the object 42. One kanji character of emptiness is applied to the kanji string 44 in the kanji template 48. The English word emptiness that represents the meaning of the kanji string 44 is applied to the hashtag 46 in the kanji template 48.

In the composite image 52, the kanji string 44 is arranged at a position overlapping the object 42. The hashtag 46 is arranged inside a region dedicated for the kanji string 44. In the composite image 52, the kanji string 44 and the hashtag 46 are foregrounds, and the image 50 is a background. In the composite image 52, a transparency process is performed on a part of the kanji string 44 and a part of the hashtag 46, and the image 50 is seen through the part of the kanji string 44 and the part of the hashtag 46.

FIG. 5 is a descriptive diagram illustrating a specific example of the composite image in a case where another subject in the image illustrated in FIG. 4 is extracted as the object. FIG. 5 illustrates a composite image 52A in a case where a building of the image 50 is recognized as the subject and is extracted as an object 42A. As a result of object analysis, the object attribute information that represents that the type of object is a building of a temple is extracted for the object 42A.

One kanji character of a temple corresponding to the object attribute information is applied to a kanji string 44A illustrated in FIG. 5. The English word temple that represents a meaning of the kanji string 44A is applied to a hashtag 46A. In the composite image 52A, the kanji string 44A is arranged at a position not in superimposition with the building of the temple away from a position of the building of the temple which is the object 42A. The hashtag 46A is arranged inside a region dedicated for the kanji string 44A.

In the composite image 52A, the kanji string 44A and the hashtag 46A are foregrounds, and the image 50 is a background. In the composite image 52A, the transparency process is performed on a part of the kanji string 44A and a part of the hashtag 46A, and the emptiness of the image 50 is seen through the part of the kanji string 44 and the part of the hashtag 46.

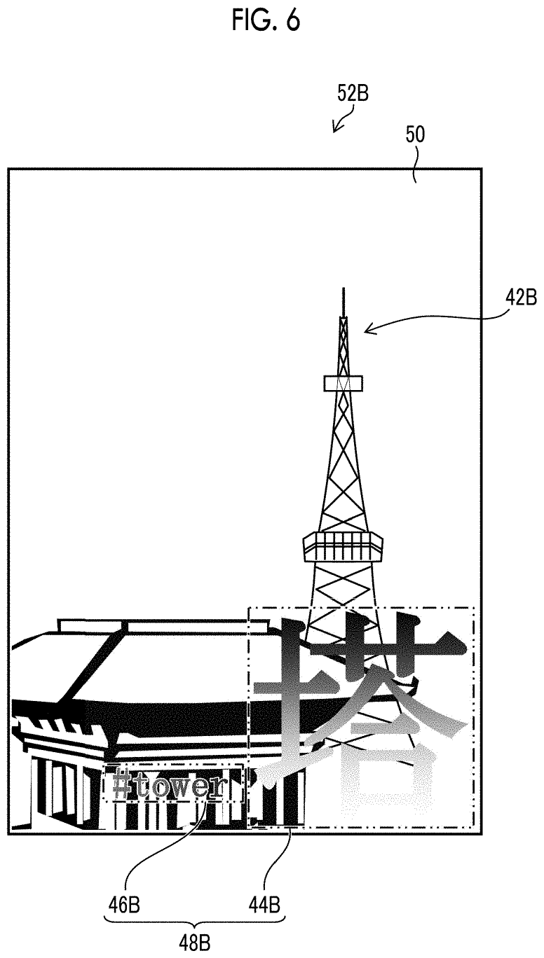

FIG. 6 is a descriptive diagram illustrating a specific example of the composite image in a case where still another subject in the image illustrated in FIG. 4 is extracted as an object 42B. FIG. 6 illustrates a composite image 52B in a case where a high-rise tower of the image 50 is recognized as the subject and is extracted as the object 42B. As a result of object analysis, the object attribute information that represents that the type of object is a building of a high-rise tower is extracted for the object 42B.

One kanji character of a tower corresponding to the object attribute information is applied to a kanji string 44B illustrated in FIG. 6. The English word tower that represents a meaning of the kanji string 44B is applied to a hashtag 46B.

In the composite image 52B, the kanji string 44B is arranged at a position overlapping the object 42B. In addition, the hashtag 46B is arranged at a position that is outside a region dedicated for the kanji string 44B away from the object 42B. In the composite image 52B, the kanji string 44B and the hashtag 46B are foregrounds, and the image 50 is a background. In the composite image 52B, the transparency process is performed on a part of the kanji string 44B and a part of the hashtag 46B, and the emptiness, the building of the temple, and the high-rise tower of the image 50 are seen through the part of the kanji string 44B and the part of the hashtag 46B.

Specific Example of Kanji Template Database

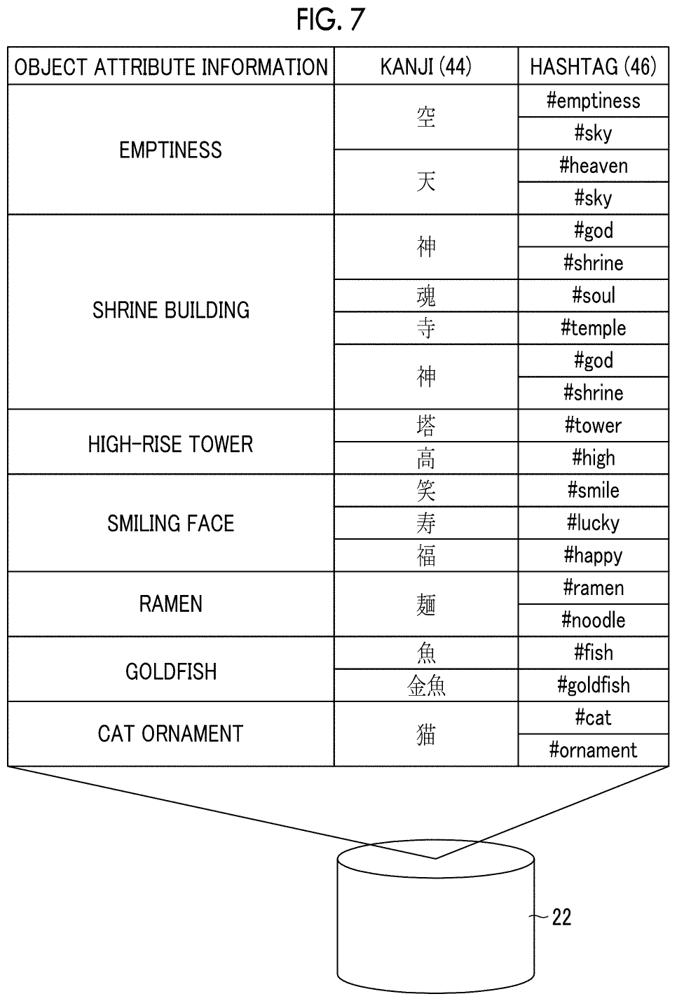

FIG. 7 is a descriptive diagram of a specific example of the kanji template database. The kanji template database 22 illustrated in FIG. 7 stores a correspondence relationship between the object attribute information and a combination of the kanji string 44 and the hashtag 46. The combination of the kanji string 44 and the hashtag 46 illustrated in FIG. 7 corresponds to the kanji template 48 illustrated in FIG. 2 and the like.

In the kanji template database 22, one or more kanji characters are associated with one object attribute information. In addition, in the kanji template database 22, one or more hashtags 46 are associated with one kanji string 44. The kanji inquiry unit 16 illustrated in FIG. 1 can selectively decide the combination of the kanji string 44 and the hashtag 46 based on one object attribute information.

In the kanji template database 22, the combination of the kanji string 44 and the hashtag 46 may be inquired using the object attribute information as a parameter. In the kanji template database 22, the object attribute information may be added, and the combination of the kanji string 44 and the hashtag 46 corresponding to the added object attribute information may be added.

The kanji template database 22 illustrated in the embodiment is applied in the kanji string decision step of deciding one or more kanji strings of a composition target from a plurality of kanji string candidates representing the object.

In addition, the kanji template database 22 illustrated in the embodiment is applied in the alphabet character string decision step of deciding an alphabet character string of a composition target from a plurality of alphabet character string candidates representing a meaning of the kanji string.

Modification Example of Kanji Inquiry Unit and Template Reading Step

A learning device that learns the correspondence relationship between the object attribute information and the kanji template 48 may be applied to the kanji inquiry unit 16 illustrated in FIG. 1 and template reading step S16 illustrated in FIG. 3. That is, the kanji inquiry unit 16 may decide the kanji template 48 corresponding to the object attribute information using a learning device that learns a correspondence relationship between the object attribute information and the kanji string 44, and a learning device that learns a correspondence relationship between the kanji string 44 and the hashtag 46.

Deep learning such as a convolutional neural network may be applied to the learning device. The kanji inquiry unit 16 to which the learning device is applied may perform re-learning using a decision result of the kanji template 48.

Effects of Image Processing System and Image Processing Method According to First Embodiment

According to the image processing system 10 and the image processing method according to the first embodiment, the following effects can be obtained.

[1] In imaging using the imaging apparatus 30 of the smartphone 10A, the composite image 52 in which the kanji string 44 related to the object 42 extracted from the image 50 and the hashtag related to the meaning of the kanji string 44 are composited with the image 50 is displayed using the liquid crystal display 24A. Accordingly, foreigners and the like who may not perceive the meaning of kanji can perceive the meaning of the kanji string 44 from the hashtag 46 and can conveniently enjoy kanji composited in the image 50.

[2] In the composite image 52, the hashtag 46 is arranged inside the region dedicated for the kanji string 44. Accordingly, the kanji string 44 and the hashtag 46 may be visually recognized together. In addition, integrity between the kanji string 44 and the hashtag 46 may be represented.

[3] In the composite image 52, the kanji string 44 and the hashtag 46 are arranged at a position overlapping the object 42. Accordingly, the composite image 52 having excellent design quality can be generated. In addition, the correspondence relationship between the object 42 and the kanji string 44 may be perceived.

[4] In the composite image 52, the kanji string 44 and the hashtag 46 are set as foregrounds, and the object 42 is set as a background. Accordingly, in the composite image 52, the kanji string 44 and the hashtag 46 can be highlighted.

[5] The transparency process is performed on a part of the kanji string 44 and the hashtag 46, and the object 42 and the like are seen through the part of the kanji string 44 and the hashtag 46. Accordingly, the kanji string 44 and the hashtag 46 can be highlighted without affecting presence of the object 42 and the like in the composite image 52.

[6] One or more kanji strings 44 and hashtags 46 are selected from a plurality of combinations of the kanji string 44 and the hashtag 46 corresponding to the object attribute information. Accordingly, the number of selections of the kanji string 44 and the hashtag 46 for one object can be increased.

Description of Image Processing System According to Second Embodiment

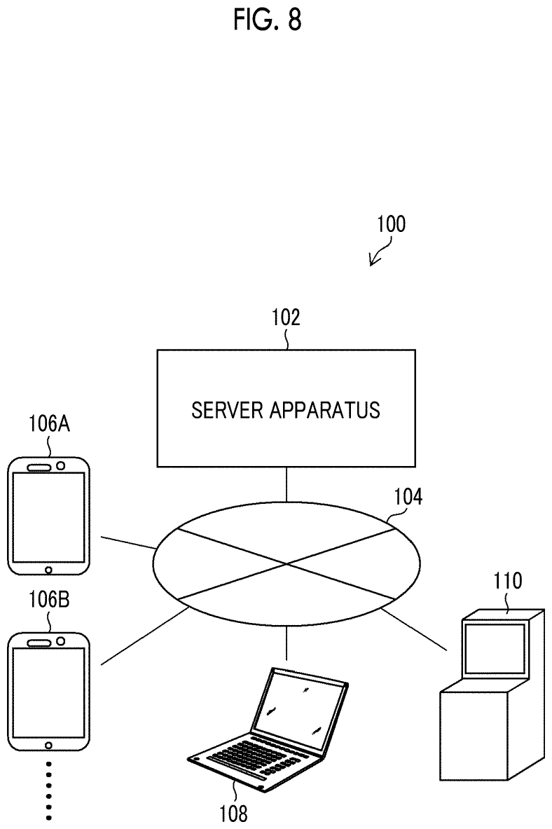

FIG. 8 is a configuration diagram of an image processing system according to a second embodiment. An image processing system 100 illustrated in FIG. 8 comprises a server apparatus 102. The server apparatus 102 is communicably connected to a terminal apparatus through a network 104.

In FIG. 8, a plurality of smartphones including a first smartphone 106A and a second smartphone 106B are illustrated as terminal apparatuses. In addition, in FIG. 8, a laptop type personal computer 108 and a self-printing terminal apparatus 110 are illustrated as other terminal apparatuses.

A hardware configuration in the image processing system 10 illustrated in FIG. 1 may be applied to the server apparatus 102 illustrated in FIG. 8. A function of the server apparatus 102 will not be described here. The server apparatus 102 comprises a communication interface, not illustrated. The server apparatus 102 is communicably connected to the network 104 through the communication interface.

The self-printing terminal apparatus 110 is installed at tourist locations such as an airport, a station, accommodations, and a store. The self-printing terminal apparatus 110 may provide a print service for printing images possessed by the tourists.

Configuration Example of Self-Printing Terminal Apparatus

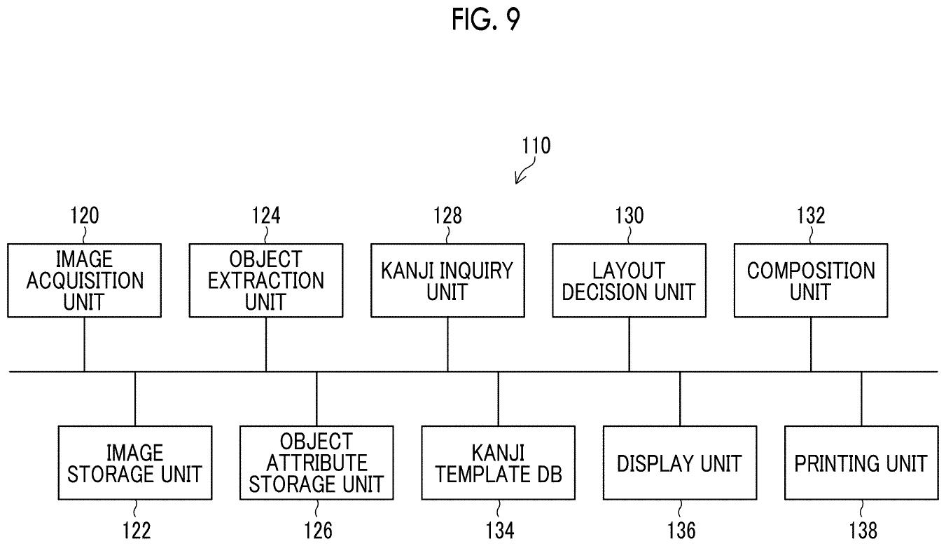

FIG. 9 is a function block diagram of the self-printing terminal apparatus illustrated in FIG. 8. The same configuration as the image processing system 10 illustrated in FIG. 1 may be applied to a hardware configuration of the self-printing terminal apparatus 110.

The self-printing terminal apparatus 110 illustrated in FIG. 8 comprises an image acquisition unit 120, an image storage unit 122, an object extraction unit 124, an object attribute information storage unit 126, a kanji inquiry unit 128, a layout decision unit 130, a composition unit 132, a kanji template database 134, and a display unit 136. In addition, the self-printing terminal apparatus 110 comprises a printing unit 138.

The image acquisition unit 120, the image storage unit 122, the object extraction unit 124, the object attribute information storage unit 126, the kanji inquiry unit 128, the layout decision unit 130, the composition unit 132, the kanji template database 134, and the display unit 136 in the self-printing terminal apparatus 110 are the same as the units of the image processing system 10 illustrated in FIG. 1. These units will not be described here.

The printing unit 138 illustrated in FIG. 9 prints the composite image. An inkjet method printing apparatus may be applied to the printing unit 138. An electrophotographic method printing apparatus may also be applied to the printing unit 138.

The image is uploaded to the self-printing terminal apparatus 110 from a terminal apparatus such as the first smartphone 106A illustrated in FIG. 8 through the network 104. The self-printing terminal apparatus 110 extracts the object and the object attribute information from the image, selects the kanji template, and decides the layout in the composite image based on the kanji template.

The self-printing terminal apparatus 110 generates the composite image based on the decided layout. The self-printing terminal apparatus 110 prints the composite image.

The kanji template database 134 illustrated in FIG. 9 may be arranged outside the self-printing terminal apparatus 110 and be communicably connected to the self-printing terminal apparatus 110 through the network 104.

The server apparatus 102 illustrated in FIG. 8 may comprise the object extraction unit 124, the object attribute information storage unit 126, the kanji inquiry unit 128, the layout decision unit 130, and the composition unit 132 in the self-printing terminal apparatus 110.

The image is uploaded to the server apparatus 102 from the terminal apparatus such as the first smartphone 106A through the network 104. The server apparatus 102 generates the composite image based on the uploaded image. The self-printing terminal apparatus 110 may download the composite image, display the composite image using the display unit 136, and print the composite image using the printing unit 138.

Flowchart of Image Processing Method According to Second Embodiment

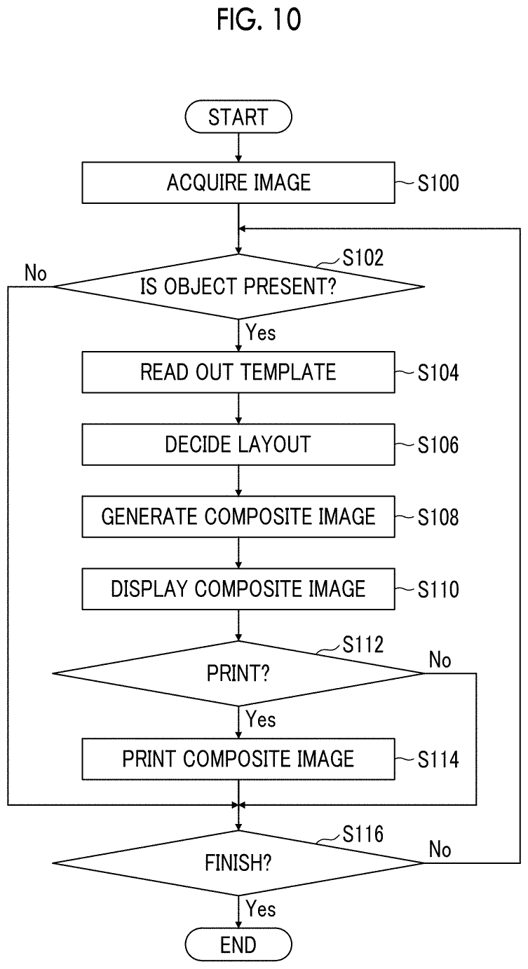

FIG. 10 is a flowchart illustrating a procedure of image processing method according to the second embodiment. Duplicate descriptions of the steps in the flowchart illustrated in FIG. 3 will be appropriately omitted below. In image acquisition step S100, the image acquisition unit 120 illustrated in FIG. 9 acquires the image of the processing target. For example, the image acquisition unit 120 may acquire the image from a memory card that is detached from the first smartphone 106A or the like capturing the image. In addition, the image acquisition unit 120 may acquire the image from a memory of the imaging apparatus through a communication port that is communicably connected to the first smartphone 106A or the like capturing the image.

In FIG. 8, the self-printing terminal apparatus 110 is wirelessly communicably connected to the first smartphone 106A or the like through the network 104. Alternatively, wired communication may be applied to communication between the self-printing terminal apparatus 110 and the first smartphone 106A or the like.

The self-printing terminal apparatus 110 may acquire the image which is uploaded to the server apparatus 102 from the first smartphone 106A or the like, from the server apparatus 102 based on an instruction signal that is transmitted from the first smartphone 106A or the like. The image acquisition unit 120 stores the acquired image in the image storage unit 122. After image acquisition step S100, the procedure of image processing method proceeds to object extraction step S102.

In object extraction step S102, the object extraction unit 124 extracts one or more objects from the acquired image. In object extraction step S102, a No determination is made in a case where the object extraction unit 124 does not extract the object. In the case of the No determination, the procedure of image processing method proceeds to finish determination step S116.

Meanwhile, in object extraction step S102, a Yes determination is made in a case where the object extraction unit 124 extracts one or more objects from the image. In the case of the Yes determination, the procedure of image processing method proceeds to template reading step S104. After template reading step S104, each step of layout decision step S106, composite image generation step S108, and composite image display step S110 is performed in this order in the procedure of image processing method.

In the steps of template reading step S104 to composite image display step S110 illustrated in FIG. 10, the same processes as the steps of template reading step S16 to composite image display step S22 illustrated in FIG. 3 are respectively performed. After composite image display step S110, the procedure of image processing method proceeds to printing determination step S112.

In printing determination step S112, the printing unit 138 determines whether or not a printing command signal is acquired. In printing determination step S112, a No determination is made in a case where it is determined that the printing unit 138 does not acquire the printing command signal. In the case of the No determination, the procedure of image processing method proceeds to finish determination step S116.

An example in which the printing unit 138 determines that the printing command signal is not acquired in printing determination step S112 is a case where buttons for selecting whether or not to perform printing are displayed on the display unit 136 and the button for selecting not to perform printing is operated.

Meanwhile, in printing determination step S112, a Yes determination is made in a case where it is determined that the printing unit 138 acquires the printing command signal. In the case of the Yes determination, the procedure of image processing method proceeds to composite image printing step S114. An example in which the printing unit 138 determines that the printing command signal is acquired in printing determination step S112 is a case where the button displayed on the display unit 136 for selecting to perform printing is operated.

In composite image printing step S114, the printing unit 138 prints the composite image. In composite image printing step S114, a printing condition setting step of setting a printing condition such as a size of printing paper, image quality, and resolution may be performed.

In addition, in printing determination step S112, a billing condition setting step of setting a billing condition for printing may be performed. The billing condition may include a payment condition such as cash payment, electronic money payment, and credit card payment. After composite image printing step S114, the procedure of image processing method proceeds to finish determination step S116.

In finish determination step S116, the self-printing terminal apparatus 110 determines whether or not a prescribed finish condition is satisfied. An example of the finish condition is a case where finishing the image processing method is selected on a finish selection screen for selecting whether or not to finish the image processing method.

In finish determination step S116, a No determination is made in a case where the self-printing terminal apparatus 110 determines that the prescribed finish condition is not satisfied. In the case of the No determination, the procedure of image processing method proceeds to object extraction step S102. Then, each step of object extraction step S102 to finish determination step S116 is repeatedly executed until a Yes determination is made in finish determination step S116.

Meanwhile, in finish determination step S116, the Yes determination is made in a case where the self-printing terminal apparatus 110 determines that the prescribed finish condition is satisfied. In the case of the Yes determination, the self-printing terminal apparatus 110 finishes the image processing method by performing a prescribed finish process.

In a case where image processing is finished, the self-printing terminal apparatus 110 may display a finish message such as character information representing that the object is not extracted from the image, and character information representing that image processing is finished, using the display unit 136.

Effects of Image Processing System and Image Processing Method According to Second Embodiment

According to the image processing system according to the second embodiment, the following effects can be obtained.

[1] The self-printing terminal apparatus 110 generates the composite image based on the image uploaded from the first smartphone 106A or the like. The self-printing terminal apparatus 110 may print the composite image using the printing unit 138. Accordingly, kanji in the composite image can be conveniently enjoyed using the printed material.

[2] The self-printing terminal apparatus 110 may download the composite image generated using the server apparatus 102 and print the downloaded composite image based on the image uploaded to the server apparatus 102 from the first smartphone 106A or the like. Accordingly, kanji in the composite image can be conveniently enjoyed using the printed material.

[3] The self-printing terminal apparatus 110 may transmit the image which is uploaded to the self-printing terminal apparatus 110 from the first smartphone 106A or the like, to the server apparatus 102, download the composite image generated using the server apparatus 102, and print the downloaded composite image. Accordingly, kanji in the composite image can be conveniently enjoyed using the printed material.

Description of Image Processing System According to Third Embodiment

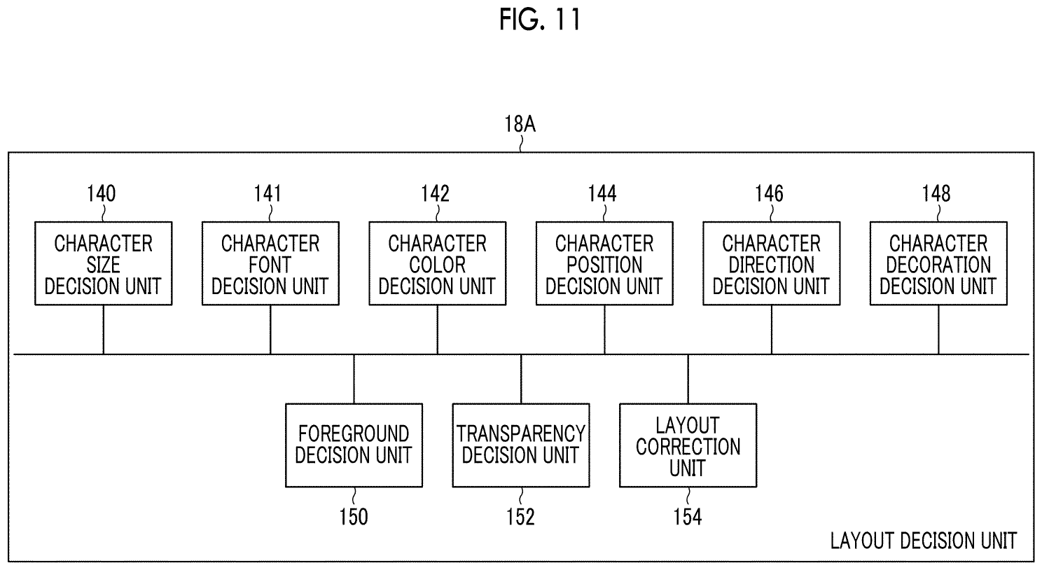

FIG. 11 is a function block diagram of a layout decision unit in an image processing system according to a third embodiment. A layout decision unit 18A comprises a character size decision unit 140, a character font decision unit 141, a character color decision unit 142, a character position decision unit 144, a character direction decision unit 146, a character decoration decision unit 148, a foreground decision unit 150, and a transparency decision unit 152.

The character size decision unit 140 decides sizes of the kanji string 44 and the hashtag 46. The character size decision unit 140 may decide the size of the kanji string 44 depending on the size and the like of the object included in the object attribute information. The character size decision unit 140 decides the size of the hashtag 46 depending on the size of the kanji string 44.

The character font decision unit 141 decides fonts of the kanji string 44 and the hashtag 46. A font that is standardized in a printing field may be applied to the fonts, or an original font may be applied to the fonts. The character font decision unit 141 may individually set the font applied to the kanji string 44 and the font applied to the hashtag 46.

The character color decision unit 142 decides colors of the kanji string 44 and the hashtag 46. The character color decision unit 142 may decide the color of the kanji string 44 depending on the color of the object included in the object attribute information. The character color decision unit 142 decides the color of the hashtag 46 depending on the color of the kanji string 44.

The character color decision unit 142 decides whether or not to apply an outline character to the kanji string 44 and the hashtag 46. The character color decision unit 142 decides a background color of the outline character in a case where the outline character is applied to the kanji string 44 and the hashtag 46. An aspect in which a character is transparent may be employed as the outline character.

The character position decision unit 144 decides positions of the kanji string 44 and the hashtag 46. Coordinates set in the acquired image 50 may be applied to the positions of the kanji string 44 and the hashtag 46. The character position decision unit 144 may decide coordinates of the kanji string 44 depending on coordinates of the object. The character position decision unit 144 may decide coordinates of the hashtag 46 depending on the coordinates of the kanji string 44. Coordinates of a center position of the kanji string 44 may be applied to the coordinates of the kanji string 44. Coordinates of a center position of the hashtag 46 may be applied to the coordinates of the hashtag 46.

The character direction decision unit 146 decides directions of the kanji string 44 and the hashtag 46. The character direction decision unit 146 may apply angles with respect to a reference direction set in the image 50 as the directions of the kanji string 44 and the hashtag 46. The character direction decision unit 146 may decide the direction of the kanji string 44 depending on the direction of the object. The character direction decision unit 146 may decide the direction of the hashtag 46 depending on the direction of the kanji string 44.

The character decoration decision unit 148 decides whether or not to perform a decoration process on the kanji string 44 and the hashtag 46. The character decoration decision unit 148 may perform the decoration process on the kanji string 44 depending on details of the kanji string 44. The character decoration decision unit 148 may perform the decoration process on the hashtag 46 depending on the decoration process performed on the kanji string 44.

The foreground decision unit 150 decides whether to set the kanji string 44 and the hashtag 46 as a foreground or a background. The foreground decision unit 150 may change initial setting in which the kanji string 44 and the hashtag 46 are set as a foreground to setting in which the kanji string 44 and the hashtag 46 are set as a background.

The transparency decision unit 152 sets degrees of transparency of the kanji string 44 and the hashtag 46 in a case where the kanji string 44 and the hashtag 46 are foregrounds. The transparency decision unit 152 may apply a transparency level as an index value that represents the degree of transparency. In a case where the kanji string 44 and the hashtag 46 correspond to the outline character, the transparency decision unit 152 decides the transparency level of the background of the outline character.

The transparency level is obtained such that a state where the background is not seen through the foreground is 0 percent and a state where the foreground is transparent is 100 percent. The transparency decision unit 152 may set the transparency levels of the kanji string 44 and the hashtag 46 to a value that exceeds 0 percent and is less than 100 percent. The transparency decision unit 152 may set the transparency level of the background of the outline character to a value that exceeds 0 percent and is less than 100 percent.

The layout decision unit 18A comprises a layout correction unit 154. The layout correction unit 154 corrects the layout in a case where the image processing system 10 receives an instruction signal representing correction of the layout.

The layout correction unit 154 may correct a character size, a character color, a character position, a character direction, and character decoration. The layout correction unit 154 may correct the foreground and the background and correct the degree and the like of transparency of the foreground.

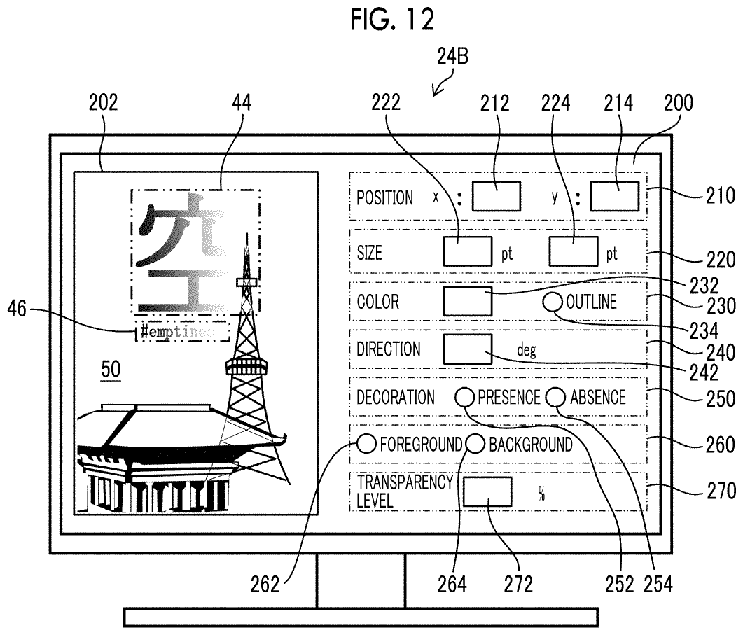

FIG. 12 is a screen diagram illustrating one example of a layout setting screen in the image processing system according to the third embodiment. A layout setting screen 200 illustrated in FIG. 12 is displayed on a display unit 24B in a case where the layout is manually set. A liquid crystal monitor apparatus that is connected to the computer may be applied to the display unit 24B.

The operator visually recognizes the layout setting screen 200 and may set the layout of the composite image by operating an operation member such as a keyboard and a mouse, not illustrated. The term setting may include a concept of correction.

The layout setting screen 200 includes a composite image display region 202. The image 50 of the processing target, the kanji string 44, and the hashtag 46 are displayed in the composite image display region 202.

The layout setting screen 200 includes a position setting region 210. The position setting region 210 includes an x coordinate value box 212 in which an x coordinate value is displayed, and a y coordinate value box 214 in which a y coordinate value is displayed.

The layout setting screen 200 includes a size setting region 220. The size setting region 220 includes a kanji point box 222 in which a point number of the kanji string 44 is displayed, and a hashtag point box 224 in which a point number of the hashtag 46 is displayed.

The layout setting screen 200 includes a color setting region 230. The color setting region 230 includes a color display box 232 that displays color, and an outline button 234 that represents whether or not to apply the outline character. The color display box 232 may display color or display a character string representing the color. In a case where the outline button 234 is checked, the color display box 232 displays the background color of the outline character.

The layout setting screen 200 includes a direction setting region 240. The direction setting region 240 includes an angle box 242 in which a value of an angle with respect to the reference direction is displayed. A reference angle of the angle with respect to the reference direction may be 0 degrees with a clockwise direction as a positive direction and a counterclockwise direction as a negative direction.

The layout setting screen 200 includes a decoration setting region 250 in which presence or absence of decoration is set. The decoration setting region 250 includes a presence button 252 that is selected in a case where decoration is performed, and an absence button 254 that is selected in a case where decoration is not performed.

The layout setting screen 200 includes a foreground setting region 260 in which the kanji string 44 and the hashtag 46 are set as a foreground or a background. The foreground setting region 260 includes a foreground selection button 262 that is selected in a case where the kanji string 44 and the hashtag 46 are set as a foreground, and a background selection button 264 that is selected in a case where the kanji string 44 and the hashtag 46 are set as a background. The layout setting screen 200 illustrated in FIG. 12 represents a state where a case of setting the kanji string 44 and the hashtag 46 as a foreground is selected.

The layout setting screen 200 includes a transparency level setting region 270 in which the transparency levels of the kanji string 44 and the hashtag 46 in a case where the kanji string 44 and the hashtag 46 are set as a foreground are set. The transparency level setting region 270 includes a transparency level box 272 in which a value of the transparency level is displayed.

An aspect in which a numerical value or the like is input, or an aspect in which a pull-down menu is displayed may be applied to the x coordinate value box 212 and the like. The layout setting screen 200 may display initial setting of composition parameters.

On the layout setting screen 200 illustrated in FIG. 12, changes such as reduction of functions can be made in correspondence with the display included in the smartphone 10A or the like illustrated in FIG. 2. In addition, it may be configured that a page is created for each setting item, and each setting can be performed while scrolling the plurality of pages.

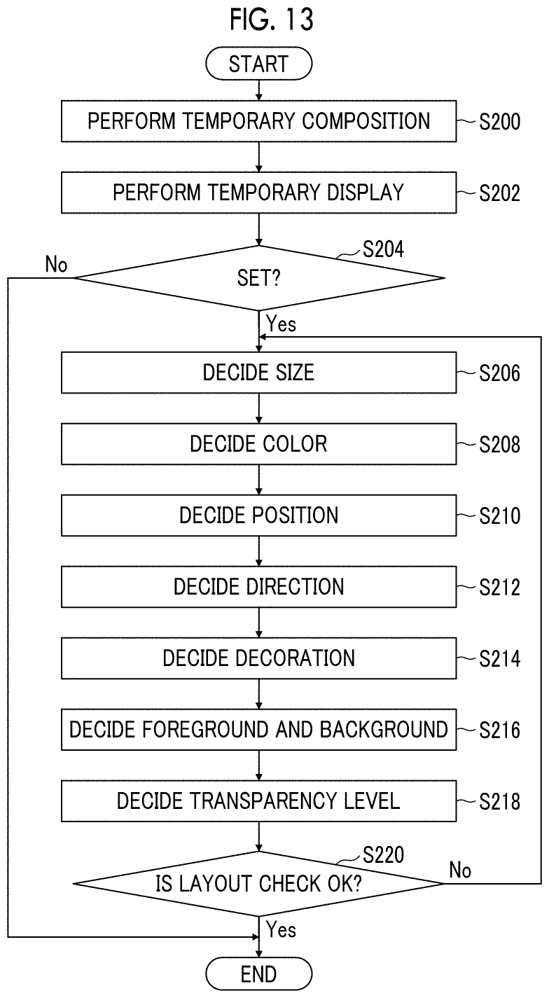

FIG. 13 is a flowchart illustrating a procedure of layout decision step in an image processing method according to the third embodiment. Each step illustrated in FIG. 13 may be applied to layout decision step S18 illustrated in FIG. 3. In temporary composition step S200, the layout decision unit 18A illustrated in FIG. 11 generates a temporary composite image in which the image 50 and the kanji template 48 are composited. After temporary composition step S200, the procedure of layout decision step proceeds to temporary display step S202.

In temporary display step S202, the layout decision unit 18A displays the temporary composite image using the liquid crystal display 24A illustrated in FIG. 2. After temporary display step S202, the procedure of layout decision step proceeds to setting determination step S204. In setting determination step S204, the layout decision unit 18A determines whether or not to set the layout for the temporary composite image.

In setting determination step S204, a No determination is made in a case where the layout decision unit 18A determines not to perform setting for the temporary composite image. In the case of the No determination, the layout decision unit 18A finishes the layout decision step and proceeds to composite image generation step S20 in FIG. 3.

Meanwhile, in setting determination step S204, a Yes determination is made in a case where the layout decision unit 18A determines to perform setting for the temporary composite image. In the case of the Yes determination, the procedure of layout decision step proceeds to size decision step S206.

In setting determination step S204, the layout decision unit 18A may display a selection screen on which it is configured that whether or not to perform setting for the temporary composite image can be selected, using the liquid crystal display 24A. A user may provide an instruction to perform setting for the temporary composite image by operating the selection screen.

In size decision step S206, the character size decision unit 140 decides a size of the kanji template 48. After size decision step S206, the procedure of image processing method proceeds to color decision step S208. In color decision step S208, the character color decision unit 142 decides a color of the kanji template 48.

In color decision step S208, the character color decision unit 142 decides whether or not to apply the outline character to the kanji template 48. In a case where the outline character is applied to the kanji template 48, the character color decision unit 142 decides the background color of the outline character.

An example of a case where the outline character is applied to the kanji template 48 in color decision step S208 is a case where the user designates application of the outline character to the kanji template 48 using a user interface.

That is, color decision step S208 may include an outline character application determination step of determining whether or not to apply the outline character to the kanji template 48, and a background color decision step of deciding the background color of the outline character. After color decision step S208, the procedure of layout decision step proceeds to position decision step S210.

In position decision step S210, the character position decision unit 144 decides a position of the kanji template 48. After position decision step S210, the procedure of image processing method proceeds to direction decision step S212. In direction decision step S212, the character direction decision unit 146 decides a direction of the kanji template 48. After direction decision step S212, the procedure of layout decision step proceeds to decoration decision step S214.

In decoration decision step S214, the character decoration decision unit 148 decides the presence or absence of decoration of the kanji template 48. The character decoration decision unit 148 decides details of decoration in a case where the kanji template 48 is decorated. After decoration decision step S214, the procedure of layout decision step proceeds to foreground and background decision step S216.

In foreground and background decision step S216, the foreground decision unit 150 decides whether or not to set the kanji template 48 as a foreground or a background. After foreground and background decision step S216, the procedure of layout decision step proceeds to transparency level decision step S218.

In transparency level decision step S218, the transparency decision unit 152 decides a transparency level of the kanji template 48. After transparency level decision step S218, the procedure of image processing method proceeds to layout check determination step S220. In layout check determination step S220, a No determination is made in a case where the layout decision unit 18A determines that the layout needs to be corrected. In the case of the No determination, the procedure of layout decision step proceeds to size decision step S206. Then, each step of size decision step S206 to layout check determination step S220 is repeatedly performed until a Yes determination is made in layout check determination step S220.

Meanwhile, in layout check determination step S220, the Yes determination is made in a case where the layout decision unit 18A determines that the layout does not need to be corrected. In the case of the Yes determination, the layout decision unit 18A finishes the layout setting step and proceeds to composite image generation step S20 in FIG. 3.

In the flowchart illustrated in FIG. 13, each step of size decision step S206 to layout check determination step S220 may be appropriately omitted. The flowchart of the layout setting step illustrated in FIG. 13 can also be applied to a flowchart in a case where the layout is corrected.

In the present embodiment, the kanji template 48 is set as a unit of decision of the size, the position, and the like. Alternatively, the size, the position, and the like may be individually decided for each of the kanji string and the alphabet character string.

Effects of Image Processing Apparatus and Image Processing Method According to Third Embodiment

According to the image processing apparatus and the image processing method according to the third embodiment, the following effects can be obtained.

[1] The size, the color, the position, and the like of the character may be decided. Accordingly, the composite image having excellent design quality may be generated. In addition, highlight of the kanji string, harmony of color in the composite image, and the like may be implemented.

[2] The layout of the composite image may be corrected. Accordingly, the composite image on which preference, taste, and the like of the user are reflected can be generated.

### Specific Example of Composite Image

### First Specific Example

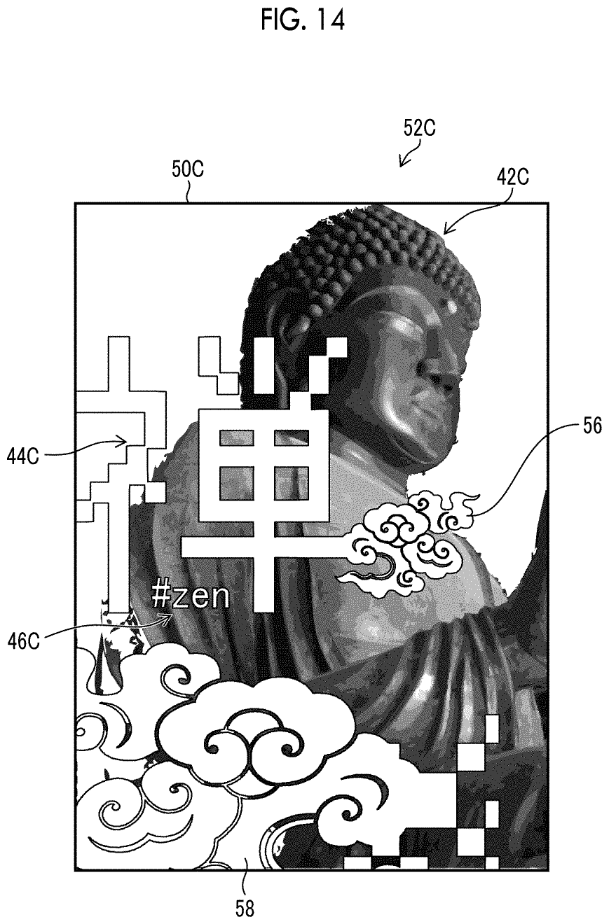

Specific examples of the composite image will be described using FIG. 14 to FIG. 22. FIG. 14 is a descriptive diagram of a composite image according to a first specific example. An image 50C in which a Buddhist statue arranged in a Buddhist sanctum is captured is applied to a composite image 52C illustrated in FIG. 14.

In the composite image 52C, zen that is related to the Buddhist statue extracted as an object 42C is composited as a kanji string 44C with the image 50C. In addition, in the composite image 52C, # zen that is related to the kanji string 44C of zen is composited as a hashtag 46C with the image 50C.

In the composite image 52C, a first FIG. 56 that images the object 42C is composited with the kanji string 44C. In addition, in the composite image 52C, a second FIG. 58 that images the object 42C is composited with the object 42C.

The same color as the kanji string 44C is applied to the first FIG. 56 and the second FIG. 58. In the present specification, the same color includes an aspect in which brightness and shade are different.

A decorative character in which a diagonal side has a stepwise shape is applied to the kanji string 44C. Meanwhile, a typical character is applied to the hashtag 46C. That is, different styles are applied to the kanji string 44C and the hashtag 46C.

In the composite image 52C according to the first specific example, the first FIG. 56 and the second FIG. 58 that image the object 42C are provided to the image 50C. Accordingly, the image of the object 42C can be enjoyed from the kanji string 44C, the first FIG. 56, and the second FIG. 58.

In addition, the kanji string 44C, the hashtag 46C, the first FIG. 56, and the second FIG. 58 have the same color. Accordingly, integrity among the kanji string 44C, the hashtag 46C, the first FIG. 56, and the second FIG. 58 is represented.

### Second Specific Example

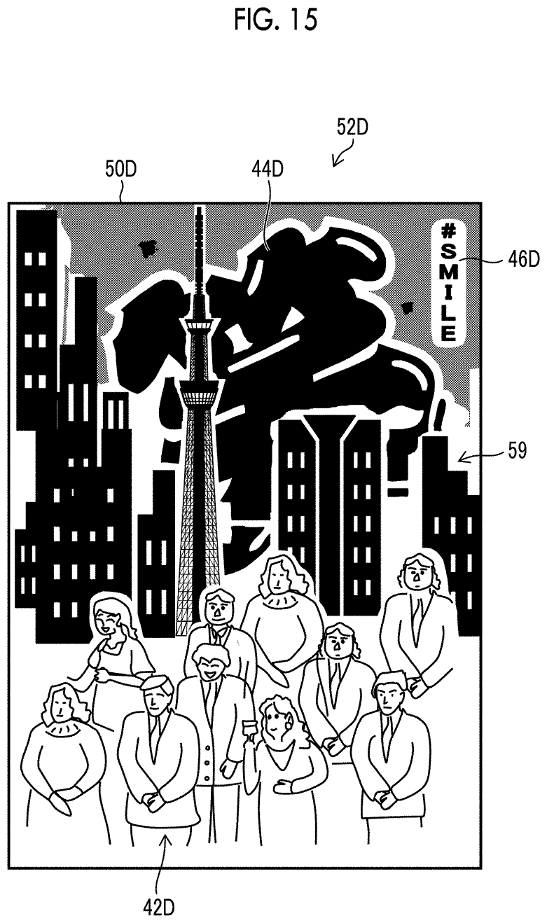

FIG. 15 is a descriptive diagram of a composite image according to a second specific example. An image 50D in which a plurality of smiling persons in a scene 59 of a city behind the persons are captured is applied to a composite image 52D illustrated in FIG. 15. The image 50D may be generated by setting the scene 59 of the city as a background, setting the plurality of persons as a foreground, and compositing both of the scene 59 and the plurality of persons. In the composite image 52D, smile that is related to the plurality of smiling persons extracted as an object 42D is composited as a kanji string 44D with the image 50D. In addition, in the composite image 52D, # SMILE that is related to the kanji string 44D of smile is composited as a hashtag 46D with the image 50D.

That is, in the composite image 52D, the kanji string 44D is cut along contours of the scene 59 of the city behind the object 42D. That is, in the composite image 52D, the object 42D and the scene 59 of the city are set as a foreground, and the kanji string 44D and the hashtag 46D are set as a background.

A decorative character having a white edge is applied to the kanji string 44D. The same color as the kanji string 44D is applied to the hashtag 46D. In addition, the same color as the edge of the kanji string 44D is applied to a background color of the hashtag 46D.

In the composite image 52D according to the second specific example, the kanji string 44D related to the object 42D can be enjoyed without affecting an atmosphere of the image 50D.

### Third Specific Example

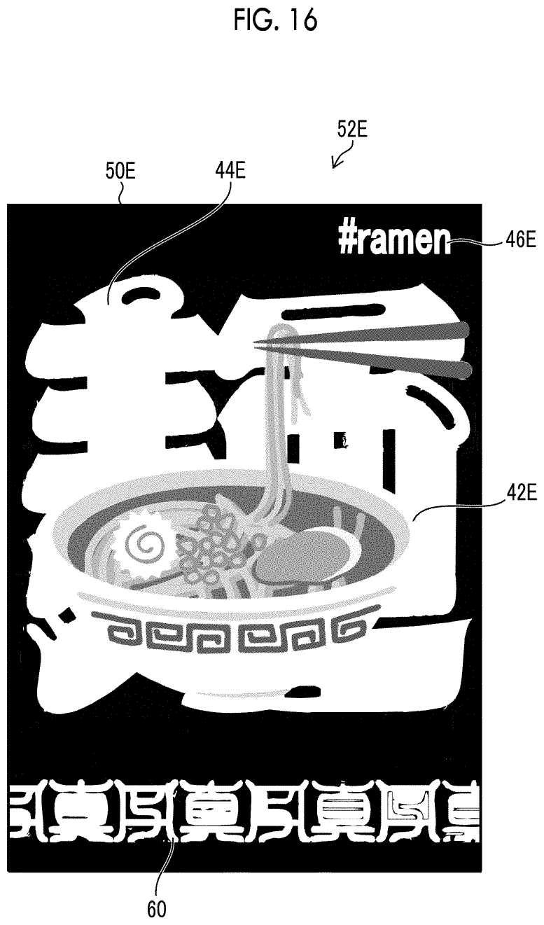

FIG. 16 is a descriptive diagram of a composite image according to a third specific example. An image 50E in which ramen is captured is applied to a composite image 52E illustrated in FIG. 16. In the composite image 52E, noodle that is related to the ramen extracted as an object 42E is composited as a kanji string 44E with the image 50E.

In addition, in the composite image 52E, # ramen that is related to the kanji string 44E of noodle is composited as a hashtag 46E with the image 50E. Furthermore, in the composite image 52E, a third FIG. 60 that resembles kanji of photograph is composited with the image 50E on a lower edge of the composite image 52E. The third FIG. 60 resembles a style of a figure represented on an outer periphery surface of a ramen bowl of the object 42E.

The outline character is applied to the kanji string 44E. The outline character is also applied to the hashtag 46E and the third FIG. 60. A background of the kanji string 44E or the like may be filled with any color or a net of any color. In the present specification, the term transparency may include a concept of semi-transparency.

In the composite image 52E, a background of the image 50E is seen in the kanji string 44E to which a relatively bold outline character is applied. In addition, in the composite image 52E, the object 42E is securely shown through the kanji string 44E.

Furthermore, in the composite image 52E, contours of at least a part of the object 42E are cut and arranged outside contours of the kanji string 44E. Furthermore, a background of the kanji string 44E is semi-transparent, and the background of the image 50E is slightly seen.

In the composite image 52E according to the third specific example, the kanji string 44E related to the object 42E can be enjoyed without affecting an atmosphere of the image 50E.

### Fourth Specific Example

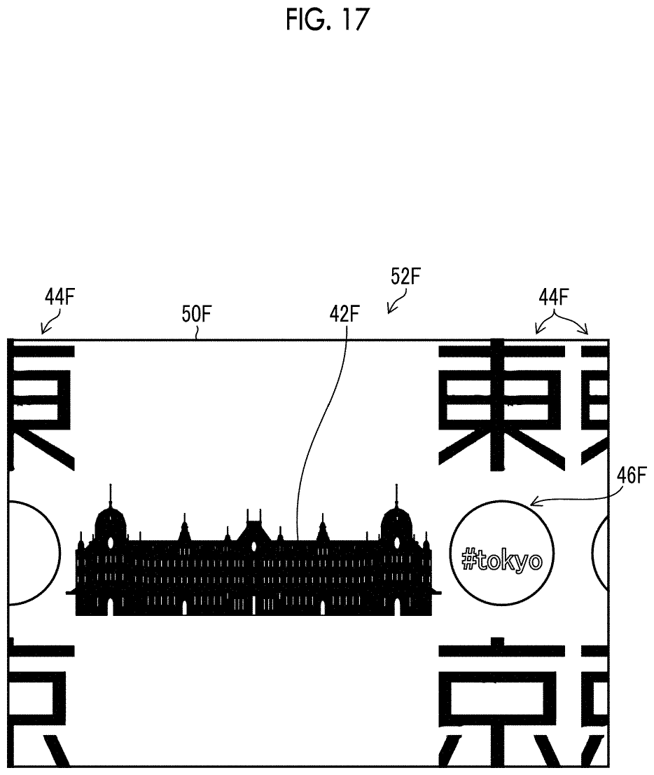

FIG. 17 is a descriptive diagram of a composite image according to a fourth specific example. An image 50F in which a station building of the Tokyo station is captured is applied to a composite image 52F illustrated in FIG. 17. In the composite image 52F, a word of two characters of Tokyo that is related to the station building of the Tokyo station extracted as an object 42F is composited as a kanji string 44F with the image 50F. In addition, in the composite image 52F, # tokyo that is related to the kanji string 44F of Tokyo is composited as a hashtag 46F with the image 50F.

In the composite image 52F, the kanji string 44F is arranged at a position in contact with the outside of the object 42F away from the object 42F. The position in contact with the outside of the object 42F may include a position in superimposition with a part of the object 42F.

In the composite image 52F, a plurality of kanji strings 44F are arranged. The plurality of kanji strings 44F are arranged at positions on both of left and right sides of the object 42F with the object 42F interposed therebetween. A color extracted from the object 42F is employed in the kanji string 44F.

In the composite image 52F according to the fourth specific example, the kanji string 44F is highlighted, and balance of color as a whole is implemented.

### Fifth Specific Example

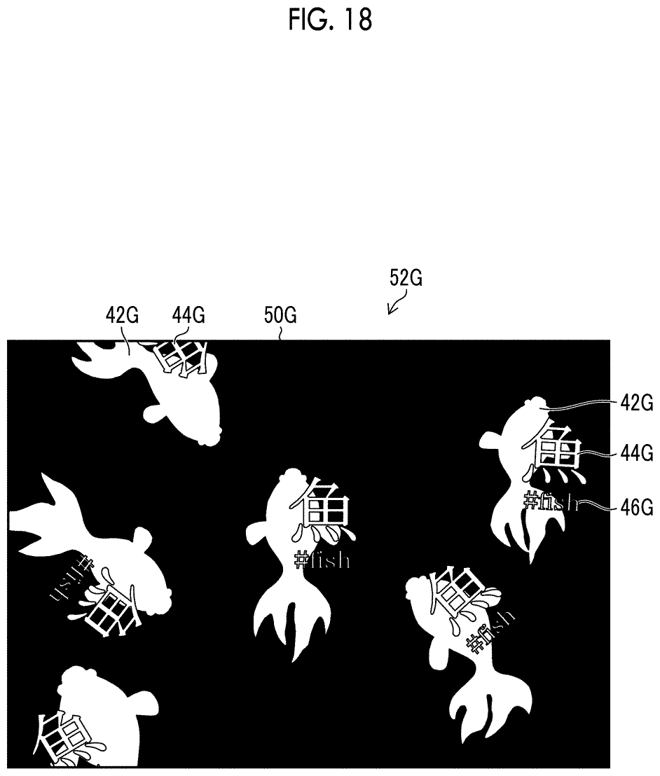

FIG. 18 is a descriptive diagram of a composite image according to a fifth specific example. An image 50G in which goldfishes swim in an aquarium are captured is applied to a composite image 52G illustrated in FIG. 18. In the composite image 52G, fish that is related to the goldfishes extracted as an object 42G is composited as a kanji string 44G with the image 50G. In addition, in the composite image 52G, # fish that is related to the kanji string 44G of fish is composited as a hashtag 46G with the image 50G.

In the composite image 52F, the kanji string 44G is composited with each of a plurality of objects 42G of the same type. In the composite image 52F, the hashtag 46G is not composited with a part of the objects 42G.

In the composite image 52F, the kanji string 44G is rotated in correspondence with a direction of the object 42G. That is, in the composite image 52F, the direction of the object 42G and a direction of the kanji string 44G are aligned. In addition, in the composite image 52F, the kanji string 44G is arranged on a contour line of the object 42G away from a center position of the object 42G.

In the composite image 52G according to the fifth specific example, the kanji string 44G is highlighted, and integrity between the object 42G and the kanji string 44G is represented.

### Sixth Specific Example

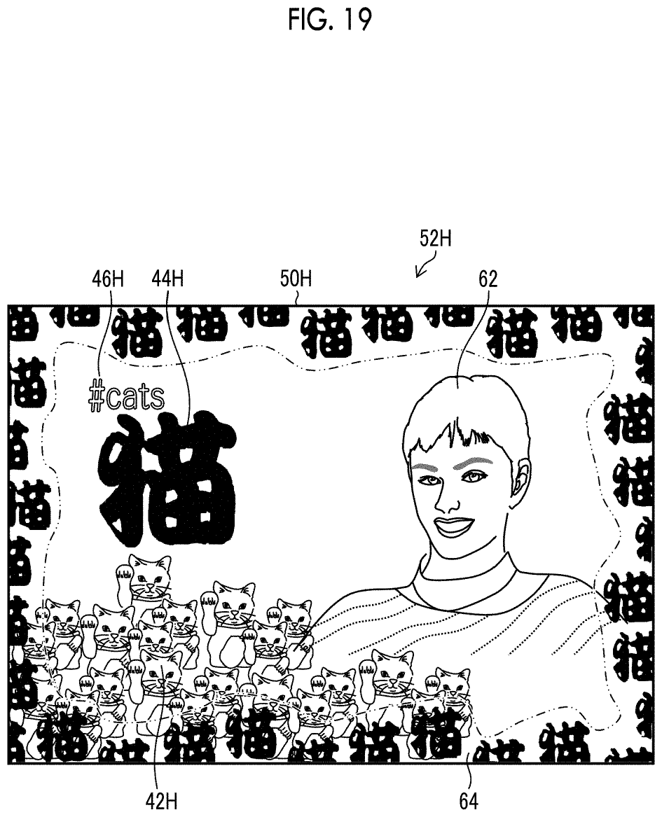

FIG. 19 is a descriptive diagram of a composite image according to a sixth specific example. An image 50H in which a person 62 is captured with a plurality of cat ornaments in a background is applied to a composite image 52H illustrated in FIG. 19. In the composite image 52H, cat that is related to the plurality of cat ornaments extracted as an object 42H is composited as a kanji string 44H with the image 50H. In addition, in the composite image 52H, # cat that is related to the kanji string 44H of cat is composited as a hashtag 46H with the image 50H.

In the composite image 52H, a frame 64 in which the same kanji as the kanji string 44H is consecutively arranged along edges is composited.

In the composite image 52H according to the sixth specific example, the kanji string 44H is highlighted, and excellent design quality is obtained.

### Seventh Specific Example

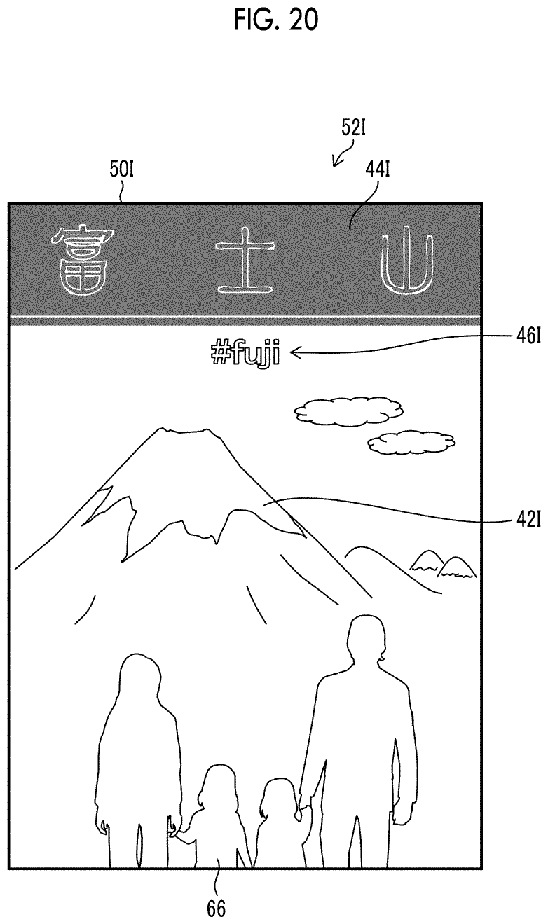

FIG. 20 is a descriptive diagram of a composite image according to a seventh specific example. An image 50I in which a plurality of persons 66 with Fujiyama behind the plurality of persons 66 are captured is applied to a composite image 52I illustrated in FIG. 20. In the composite image 52I, a word of Fujiyama that is configured with three kanji characters and is related to Fujiyama extracted as an object 42I is composited as a kanji string 44I with the image 50I. In addition, in the composite image 52I, # fuji that is related to the kanji string 44I of Fujiyama is composited as a hashtag 46I with the image 50I.

In the composite image 52I, the kanji string 44I is arranged at a center position of the image 50I in a left-right direction. That is, in the composite image 52I, the kanji string 44I is arranged at the center position of the image 50I in a direction in which the characters constituting the kanji string 44I are arranged.

In the composite image 52I according to the seventh specific example, presence of the object 42I in the image 50I is maintained, and excellent design quality is obtained as a whole.

### Eighth Specific Example

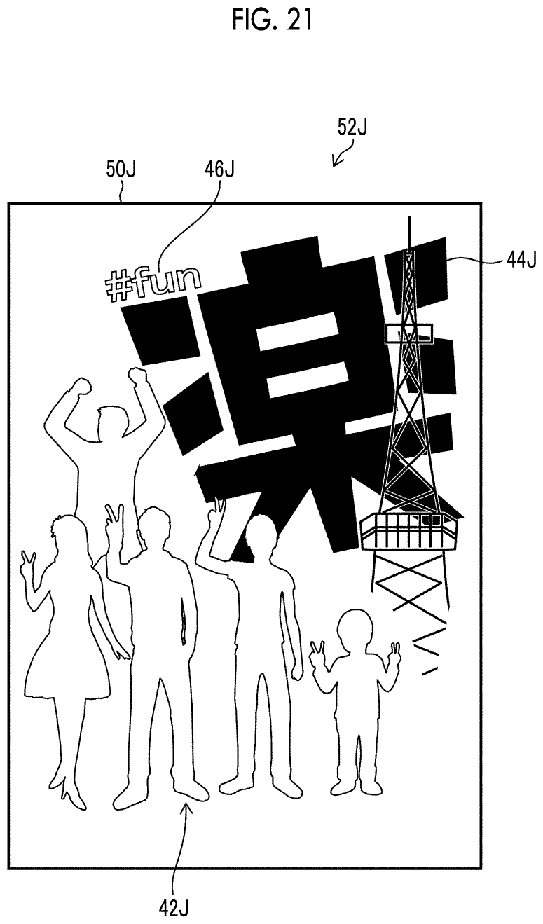

FIG. 21 is a descriptive diagram of a composite image according to an eighth specific example. An image 50J in which a plurality of persons taking a joyful pose are captured is applied to a composite image 52J illustrated in FIG. 21. The image 50J may be composited with the plurality of persons as a foreground and a high-rise tower as a background.

In the composite image 52J, a word of fun that is related to the plurality of persons who are taking a joyful pose and are extracted as an object 42J is composited as a kanji string 44J with the image 50J. In addition, in the composite image 52J, # fun that is related to the kanji string 44J of fun is composited as a hashtag 46J with the image 50J.

In the composite image 52J, the kanji string 44J is semi-transparent, and the background of the image 50J is seen through the kanji string 44J. In the composite image 52J, the object 42J is decided as a foreground, and the kanji string 44J is decided as a background.

In the composite image 52J according to the eighth specific example, presence of the object 42J in the image 50J is maintained, and the background of the image 50J may be visually recognized.

### Ninth Specific Example

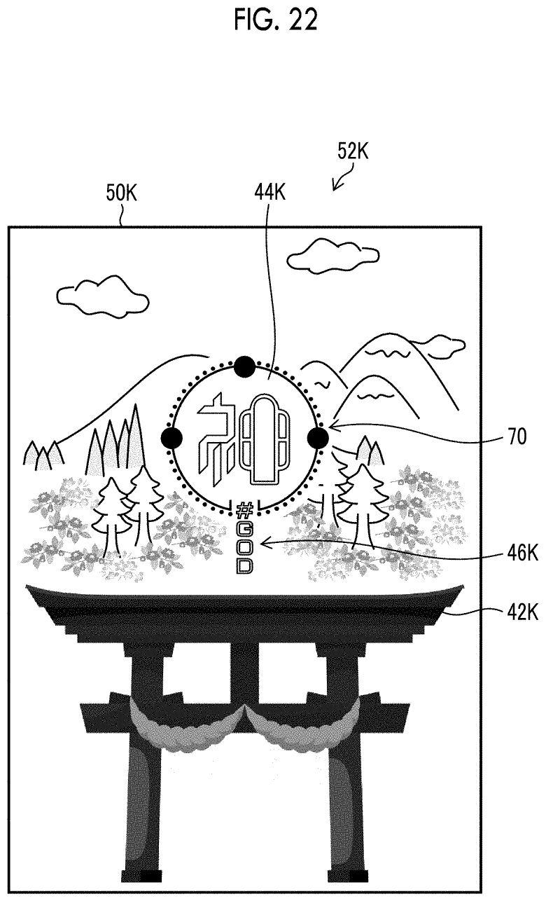

FIG. 22 is a descriptive diagram of a composite image according to a ninth specific example. An image 50K in which a torii is captured is applied to a composite image 52K illustrated in FIG. 22. In the composite image 52K, a word of god that is related to the torii extracted as an object 42K is composited as a kanji string 44K with the image 50K. In addition, in the composite image 52K, # god that is related to the kanji string 44K of god is composited as a hashtag 46K with the image 50K.

In the composite image 52K, a center position of the image 50K in the left-right direction and a center position of the kanji string 44K are arranged in alignment in correspondence with the object 42K that is left-right symmetric. In addition, a decoration 70 that represents an atmosphere of the kanji string 44K is provided on the kanji string 44K. Furthermore, in the composite image 52K, the center position of the image 50K in the left-right direction and a center position of the hashtag 46K are arranged in alignment.

In the composite image 52K according to the ninth specific example, a design that highlights unity of the object 42K, the kanji string 44K, and the hashtag 46K and prioritizes symmetry is employed.

### Tenth Specific Example

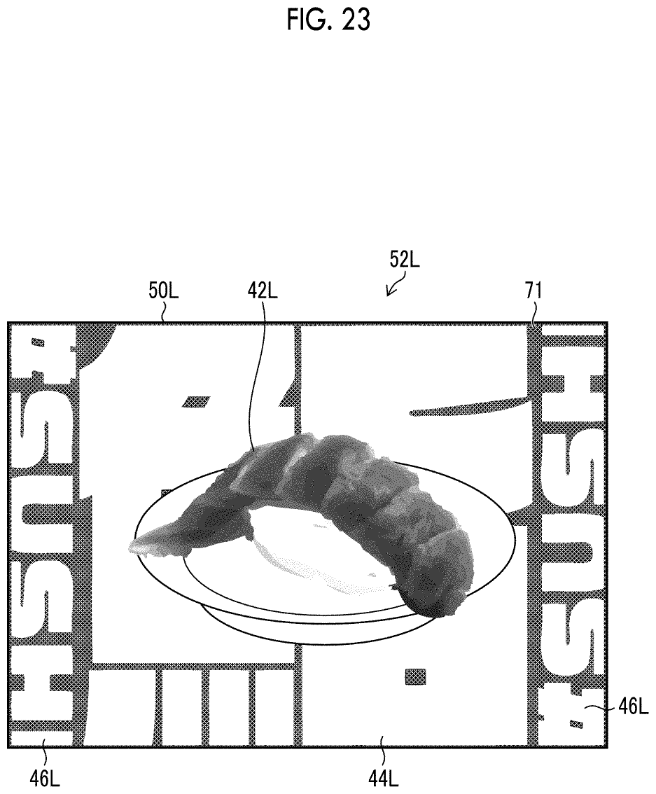

FIG. 23 is a descriptive diagram of a composite image according to a tenth specific example. An image 50L in which sushi served in a dish is captured is applied to a composite image 52L illustrated in FIG. 23. In the composite image 52L, a word of sushi that is related to the sushi extracted as an object 42L is composited as a kanji string 44L with the image 50L. In addition, in the composite image 52L, # SUSHI that is related to the kanji string 44L of sushi is composited as a hashtag 46L with the image 50L.

The outline character is applied to the kanji string 44L. A color that is used in the object 42L is applied to a background 71 of the outline character. In addition, in the composite image 52L, two hashtags 46L are applied to one kanji string 44L. In the composite image 52L, a center of the kanji string 44L is arranged at a center position of the composite image 52L, and the two hashtags 46L are arranged in a left-right symmetry about the kanji string 44L. The two hashtags 46L are set in directions opposite to each other.

In the composite image 52L according to the tenth specific example, a design that has unity of color as a whole and prioritizes symmetry is employed. Capital characters may be applied to alphabets applied to the hashtag 46L. Only the initial of the alphabets applied to the hashtag 46L may be a capital character. A plurality of hashtags 46L may be composited with one kanji string 44L.

### Eleventh Specific Example

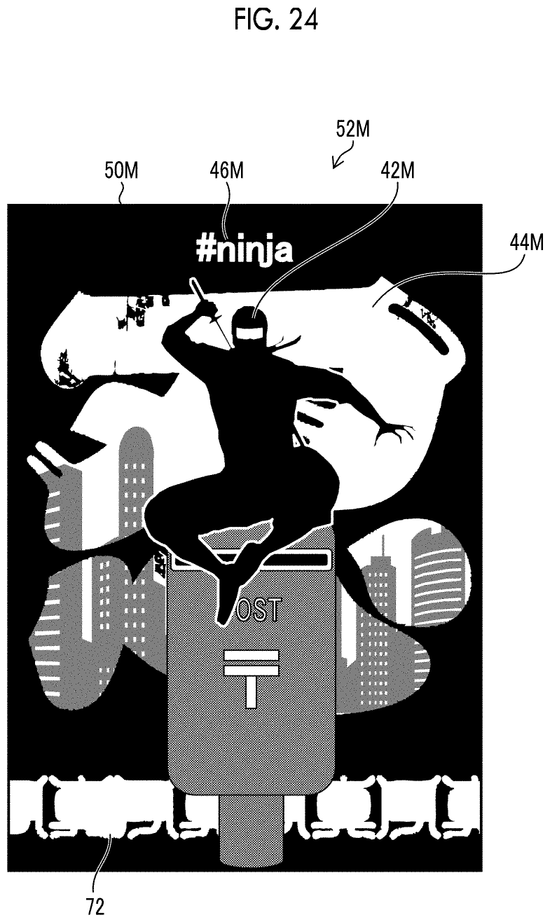

FIG. 24 is a descriptive diagram of a composite image according to an eleventh specific example. An image 50M that is obtained by compositing an image in which a person sits on a postbox with an image in which a daytime scene of a downtown street is captured is applied to a composite image 52M illustrated in FIG. 24. In the composite image 52M, a word of ninja that is related to the person extracted as an object 42M is composited as a kanji string 44M with the image 50M. In addition, in the composite image 52M, # ninja that is related to a meaning of the kanji string 44M of ninja is composited as a hashtag 46M with the image 50M.

In the composite image 52M, a fourth FIG. 72 that is the same as the third FIG. 60 illustrated in FIG. 16 is composited with the image 50M on a lower edge of the composite image 52M.

In the composite image 52M, the person sitting on the postbox constituting the image 50M is the foremost plane of the kanji string 44M, and the scene of the daytime downtown stress constituting the image 50M is the rearmost plane in the composite image 52M.

In the composite image 52M according to the eleventh specific example, an image in which two images are composited is applied as the image 50M. One of the two images is the foremost plane, and the other is the rearmost plane. By doing so, kanji can be enjoyed by compositing various images.

### Twelfth Specific Example

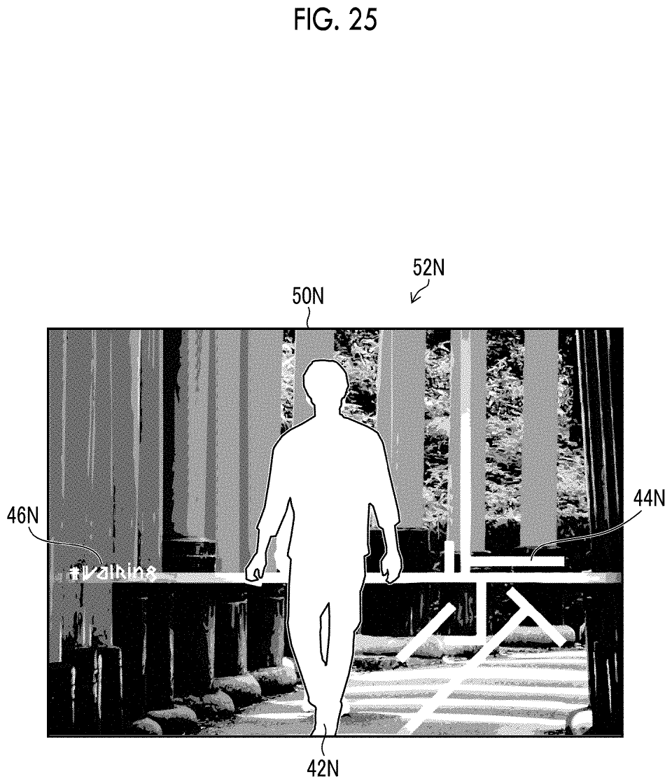

FIG. 25 is a descriptive diagram of a composite image according to a twelfth specific example. An image 50N in which a person walking on a sando is captured is applied to a composite image 52N illustrated in FIG. 25. In the composite image 52N, a word of walking that is related to the person who is walking on the sando and is extracted as an object 42N is composited as a kanji string 44N with the image 50N. In addition, in the composite image 52N, # walking that is related to a meaning of the kanji string 44N of walking is composited as a hashtag 46N with the image 50N.

In the composite image 52N, the kanji string 44N is deformed in accordance with a space, and arrangement of the kanji string 44N that is spatially in harmony is implemented. The kanji string 44N is deformed in accordance with a shape of the sando in the image 50N.

In the composite image 52N according to the twelfth specific example, the deformation and the arrangement of the kanji string 44N that is spatially in harmony are applied, and excellent design quality is obtained.

### Thirteenth Specific Example

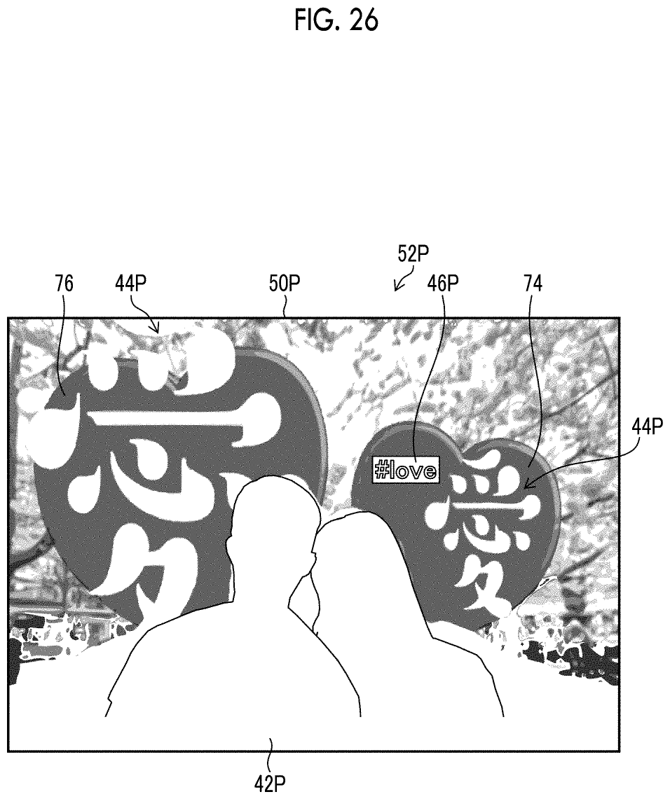

FIG. 26 is a descriptive diagram of a composite image according to a thirteenth specific example. An image 50P in which a couple is captured is applied to a composite image 52P illustrated in FIG. 26. In the composite image 52P, a word of love that is related to the couple extracted as an object 42P is composited as a kanji string 44P with the image 50P. In addition, in the composite image 52P, # love that is related to a meaning of the kanji string 44P of love is composited as a hashtag 46P with the image 50P.

In the composite image 52P, one kanji string 44P is arranged at a position of a shoulder of each of two persons away from faces of the object 42P. A fifth FIG. 74 is composited with a background of one of two kanji strings 44P and a sixth FIG. 76 is composited with a background of the other. The hashtag 46P is arranged at only a position in superimposition with the fifth FIG. 74 between the two kanji strings 44P.

In the composite image 52P according to the thirteenth specific example, a plurality of kanji strings 44P are arranged away from the faces of the object 42P. Accordingly, integrity between the object 42P and the kanji strings 44P is represented. In addition, the fifth FIG. 74 and the sixth FIG. 76 are superimposed on the kanji strings 44P. Accordingly, the kanji strings 44P having excellent design quality can be applied.

Application Example for Program Causing Computer to Function as Image Processing System

The image processing method and the image processing system described above can be configured as a program that implements a function corresponding to each step in the image processing method or each step in the image processing system using a computer.

For example, a program that implements an image analysis function of analyzing the acquired image 50 and extracting the object 42, a kanji string decision function of deciding a kanji string related to the object, an alphabet character string decision function of deciding an alphabet character string related to a meaning of the kanji, a layout decision function of deciding a layout of a composite image, and a composition function of generating the composite image based on the layout may be configured.

The program that causes the computer to implement an image processing function described above can be stored in a computer-readable information storage medium that is a non-transitory information storage medium and is a tangible object, and the program can be provided through the information storage medium.

In addition, an aspect in which a program signal is provided through a communication network can be available instead of an aspect in which the program is stored in the non-transitory information storage medium.

### Combination of Embodiment, Modification Example, and Like

Constituents described in the embodiments and constituents described in the modification example can be appropriately used in combination. In addition, a part of the constituents may be replaced.

In the embodiments of the present invention described thus far, constituents can be appropriately changed, added, or removed without departing from a gist of the present invention. The present invention is not limited to the embodiments described thus far and can be subjected to various modifications within a technical idea of the present invention by those having ordinary knowledge in the field.

### EXPLANATION OF REFERENCES

10: image processing system
10A: smartphone
12: image acquisition unit
13: image storage unit
14: object extraction unit
15: object attribute information storage unit
16: kanji inquiry unit
18: layout decision unit
18A: layout decision unit
20: composition unit
22: kanji template database
24: display unit
24A: liquid crystal display
24B: display unit
26: composite image storage unit
30: imaging apparatus
42: object
42A: object
42B: object
42C: object
42D: object
42E: object
42F: object
42G: object
42H: object
42I: object
42J: object
42K: object
42L: object
42M: object
42N: object
42P: object
44: kanji string
44A: kanji string
44B: kanji string
44C: kanji string
44D: kanji string
44E: kanji string
44F: kanji string
44G: kanji string
44H: kanji string
44I: kanji string
44J: kanji string
44K: kanji string
44L: kanji string
44M: kanji string
44N: kanji string
44P: kanji string
46: hashtag
46A: hashtag
46B: hashtag
46C: hashtag
46D: hashtag
46E: hashtag
46F: hashtag
46G: hashtag
46H: hashtag
46I: hashtag
46J: hashtag
46K: hashtag
46L: hashtag
46M: hashtag
46N: hashtag
46P: hashtag
48: kanji template
50: image
50C: image
50D: image
50E: image
50F: image
50G: image
50H: image
50I: image
50J: image
50K: image
50L: image
50M: image
50N: image
50P: image
52: composite image
52A: composite image
52B: composite image
52C: composite image
52D: composite image
52E: composite image
52F: composite image
52G: composite image
52H: composite image
52I: composite image
52J: composite image
52K: composite image
52L: composite image
52M: composite image
52N: composite image
52P: composite image
56: first FIG.
58: second FIG.
59: scene
60: third FIG.
62: person
64: frame
66: person
70: decoration
71: background of outline character
72: fourth FIG.
74: fifth FIG.
76: sixth FIG.
100: image processing system
102: server apparatus
104: network
106A: first smartphone
106B: second smartphone
108: laptop type personal computer
110: self-printing terminal apparatus
120: image acquisition unit
122: image storage unit
124: object extraction unit
126: object attribute information storage unit
128: kanji inquiry unit
130: layout decision unit
132: composition unit
134: kanji template database
136: display unit
138: printing unit
140: character size decision unit
142: character color decision unit
144: character position decision unit
146: character direction decision unit
148: character decoration decision unit
150: foreground decision unit
152: transparency decision unit
154: layout correction unit
200: layout setting screen
202: composite image display region
210: position setting region
212: x coordinate value box
214: y coordinate value box
220: size setting region
222: kanji point box
224: hashtag point box
230: color setting region
232: color display box
234: outline button
240: direction setting region
242: angle box
250: decoration setting region
252: presence button
254: absence button
260: foreground setting region
262: foreground selection button
264: background selection button
270: transparency level setting region
272: transparency level box
S10 to S28, S100 to S116, S200 to S220: each step of image processing method

What is claimed is:

1. An image processing method comprising:
an image analysis step of analyzing an image and extracting an object from the image;
a kanji string decision step of deciding a kanji string that includes one or more kanji characters related to the object;
an alphabet character string decision step of deciding an alphabet character string related to a meaning of the kanji string;
a layout decision step of deciding a layout in which the kanji string and the alphabet character string are composited with the image as a decided layout; and
a composition step of generating a composite image by compositing the kanji string and the alphabet character string with the image based on the decided layout.

2. The image processing method according to claim 1,
wherein in the layout decision step, a layout in which the alphabet character string is arranged in a region in which the kanji string is arranged is decided as the decided layout.

3. The image processing method according to claim 1,
wherein in the layout decision step, a layout in which at least a part of the kanji string is arranged at a position overlapping the object is decided as the decided layout.

4. The image processing method according to claim 1,
wherein in the layout decision step, a layout in which the kanji string is arranged in a foreground of the object is decided as the decided layout.

5. The image processing method according to claim 1,
wherein in the layout decision step, a layout in which the object is arranged in a foreground of the kanji string is decided as the decided layout.

6. The image processing method according to claim 1,
wherein in the layout decision step, a layout in which the object is seen through at least a part of the kanji string is decided as the decided layout.

7. The image processing method according to claim 1,
wherein in the image analysis step, a color used in the object is extracted as a extracted color, and
in the layout decision step, the extracted color is employed as a color of the kanji string.

8. The image processing method according to claim 1,
wherein in the image analysis step, a plurality of the objects are extracted from the image, and
in the layout decision step, a layout in which the kanji string is arranged in each of the plurality of objects is decided as the decided layout.

9. The image processing method according to claim 1,
wherein in the layout decision step, a layout in which the kanji string is arranged in a direction corresponding to a direction of the object is decided as the decided layout.

10. The image processing method according to claim 1,
wherein in the layout decision step, a layout in which one or more kanji characters included in the kanji string are arranged on an edge of the image is decided as the decided layout.

11. The image processing method according to claim 1,
wherein in the kanji string decision step, the kanji string are decided from a plurality of kanji string candidates related to the object.

12. The image processing method according to claim 1,
wherein in the alphabet character string decision step, the alphabet character string is decided from a plurality of alphabet character string candidates related to the meaning of the kanji string.

13. The image processing method according to claim 1, further comprising:
a kanji string correction step of correcting the kanji string to another kanji string related to the object.

14. The image processing method according to claim 1, further comprising:
an alphabet character string correction step of correcting the alphabet character string to another alphabet character string related to the meaning of the kanji string.

15. The image processing method according to claim 1, further comprising:
a printing step of printing the composite image using a printer.

16. A non-transitory, computer-readable recording medium which records a program causing a computer to implement:
an image analysis function of analyzing an acquired image and extracting an object from the image;
a kanji string decision function of deciding a kanji string that includes one or more kanji characters related to the object;
an alphabet character string decision function of deciding an alphabet character string related to a meaning of the kanji string;
a layout decision function of deciding a layout in which the kanji string and the alphabet character string are composited with the image; and
a composition function of generating a composite image by compositing the kanji string and the alphabet character string with the image based on the layout.

17. An image processing system including at least one processor,
wherein the at least one processor is configured to:
analyze an acquired image and extracts an object from the image;
decide a kanji string which includes one or more kanji characters related to the object;
decide an alphabet character string related to a meaning of the kanji string;
decide a layout in which the kanji string and the alphabet character string are composited with the image; and
generate a composite image by compositing the kanji string and the alphabet character string with the image based on the layout.

18. The image processing system according to claim 17,
wherein the at least one processor is configured to cause a printer to print the composite image.

19. The image processing system according to claim 17, further comprising
a printer that is connected through a network,
wherein the printer is configured to print the composite image.

20. The image processing system according to claim 19,
wherein the printer includes the at least one processor and is configured to print the composite image based on the image.

21. The image processing system according to claim 17, further comprising
a server apparatus that is connected through a network,
wherein the server apparatus includes the at least one processor.
